(19) United States
(12) Patent Application Publication
(10) Pub. No.: US 2026/0027510 A1
(43) Pub. Date: Jan. 29, 2026

(54) SYSTEM AND METHOD FOR OPERATING GAS TREATMENT SYSTEM TO TREAT EXHAUST GAS OR AIR

(71) Applicant: GE INFRASTRUCTURE TECHNOLOGY LLC, Greenville, SC (US)

(72) Inventors: Kyle David SOLOMON, Greenville, SC (US); Scott Francis JOHNSON, Greenville, SC (US); John Farrior WOODALL, Greenville, SC (US); Joel Meador HALL, Greenville, SC (US)

(21) Appl. No.: 19/145,130

(22) PCT Filed: Jan. 6, 2023
(86) PCT No.: PCT/US2023/010343

§ 371 Date: Jul. 1, 2025

(51) Int. Cl. B01D 53/04; B01D 53/92

(52) U.S. Cl. CPC B01D 53/0462; B01D 53/92; B01D 2257/504; B01D 2259/40009

(57) ABSTRACT

A gas treatment system having a first gas capture system configured to at least partially capture an undesirable gas, and at least one gas capture system configured to at least partially capture the undesirable gas. The gas treatment system also includes an exhaust flow path through the at least one gas capture system, an airflow path through the at least one gas capture system, and at least one flow control. The at least one flow control is configured to direct an exhaust gas from a combustion system through the exhaust flow path in a first control mode to enable gas capture from the exhaust gas by the at least one gas capture system, wherein the at least one flow control is configured to direct an airflow through the airflow path in a second control mode to enable gas capture from the airflow by the at least one gas capture system.

### BACKGROUND

The present application relates generally to a system and method for operating a gas treatment system to treat exhaust gas or air, such as for a power plant using a combustion system as a source of energy to generate electricity.

An industrial plant, such as a power plant, may produce a variety of gases, such as an exhaust gas of a combustion system. The combustion system may include a gas turbine engine or system, a reciprocating piston-cylinder engine, a furnace, a boiler, or other industrial equipment. These exhaust gases may include one or more undesirable gases, such as acid gases and/or greenhouse gases. For example, the undesirable gases may include carbon oxides such as carbon dioxide (CO₂) and carbon monoxide (CO), nitrogen oxides such as nitrogen dioxide (NO₂), and/or sulfur oxides such as sulfur dioxide (SO₂). CO₂ is both an acid gas and a greenhouse gas. Unfortunately, the atmospheric content of CO₂ has generally increased over thousands of years, and currently exceeds about 420 parts per million by volume (ppmv) or 643 parts per million by weight (ppmw) in the atmosphere. With various regulations and environmental concerns regarding global warming, it would be desirable to reduce the output of undesirable gases (e.g., CO₂) into the atmosphere, particularly for hydrocarbon fuel consuming equipment such as combustion systems.

### BRIEF DESCRIPTION

Certain embodiments commensurate in scope with the originally claimed subject matter are summarized below. These embodiments are not intended to limit the scope of the claimed embodiments, but rather these embodiments are intended only to provide a brief summary of possible forms of the subject matter. Indeed, the presently claimed embodiments may encompass a variety of forms that may be similar to or different from the embodiments set forth below.

In certain embodiments, a system includes a gas treatment system having a first gas capture system configured to at least partially capture an undesirable gas, and at least one gas capture system configured to at least partially capture the undesirable gas. The gas treatment system also includes an exhaust flow path through the at least one gas capture system, an airflow path through the at least one gas capture system, and at least one flow control. The at least one flow control is configured to direct an exhaust gas from a combustion system through the exhaust flow path in a first control mode to enable gas capture from the exhaust gas by the at least one gas capture system, wherein the at least one flow control is configured to direct an airflow through the airflow path in a second control mode to enable gas capture from the airflow by the at least one gas capture system.

In certain embodiments, a system includes a controller having a memory, a processor, and instructions stored on the memory and executable by the processor to change operating modes between a first control mode and a second control mode of a gas treatment system, wherein the gas treatment system includes at least one gas capture system configured to at least partially capture an undesirable gas. The controller is configured to control at least one flow control to direct an exhaust gas from a combustion system through the at least one gas capture system along an exhaust flow path in the first control mode, wherein the first control mode enables gas capture from the exhaust gas by the at least one gas capture system. The controller is configured to control the at least one flow control to direct an airflow through the at least one gas capture system along an airflow path in the second control mode, wherein the second control mode enables gas capture from the airflow by the at least one gas capture system.

In certain embodiments, a method includes changing operating modes between a first control mode and a second control mode of a gas treatment system, wherein the gas treatment system includes at least one gas capture system configured to at least partially capture an undesirable gas. The method includes controlling at least one flow control to direct an exhaust gas from a combustion system through the at least one gas capture system along an exhaust flow path in the first control mode, wherein the first control mode enables gas capture from the exhaust gas by the at least one gas capture system. The method includes controlling the at least one flow control to direct an airflow through the at least one gas capture system along an airflow path in the second control mode, wherein the second control mode enables gas capture from the airflow by the at least one gas capture system.

### BRIEF DESCRIPTION OF THE DRAWINGS

These and other features, aspects, and advantages of the presently disclosed techniques will become better understood when the following detailed description is read with reference to the accompanying drawings in which like characters represent like parts throughout the drawings, wherein:

FIG. 1 is a schematic of an embodiment of a combined cycle power plant having a gas turbine system, a heat recovery steam generator (HRSG), a steam turbine system, and a multi-stage gas treatment system having a plurality of gas capture systems configured to capture an undesirable gas (e.g., CO₂).

FIG. 2 is a schematic of an embodiment of a gas capture system of the multi-stage gas treatment system of FIG. 1, illustrating a sorbent-based gas capture system.

FIG. 3 is a schematic of an embodiment of a gas capture system of the multi-stage gas treatment system of FIG. 1, illustrating a solvent-based gas capture system.

FIG. 4 is a schematic of an embodiment of the combined cycle power plant of FIG. 1, further illustrating details of a multi-mode configuration for selectively operating in the power production mode and the power consumption mode.

FIG. 5 is a schematic of an embodiment of a power plant, wherein the power plant has the multi-mode configuration for selectively operating in the power production mode and the power consumption mode.

FIG. 6 is a schematic of an embodiment of the combined cycle power plant of FIGS. 1 and 4, further illustrating a plurality of power trains having gas turbine systems, steam turbine systems, HRSG's, and motor-generators.

FIG. 7 is a schematic of an embodiment of the power plant of FIG. 5, further illustrating a plurality of power trains having the combustion systems, the steam generators, the air movers, the steam turbines, and the motor-generators.

FIG. 8 is a flow chart of an embodiment of a process for controlling operation of a power plant in the power production mode and the power consumption mode as discussed in detail above with reference to FIGS. 1-7.

### DETAILED DESCRIPTION

One or more specific embodiments of the presently disclosed systems are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the presently disclosed embodiments, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include systems and methods to reduce the carbon footprint of combustion systems, such as combustion driven power plants. For example, the disclosed embodiments may reduce the carbon footprint of the power plant to be at least carbon neutral or carbon negative. However, the disclosed embodiments are not limited to a carbon neutral or carbon negative footprint, and thus any reduction of the carbon footprint of the power plant is within the scope of the disclosed embodiments. In context of the present application, any reference to a target or goal of carbon neutral or carbon negative is intended as a non-limiting example.

As discussed below, the disclosed embodiments selectively operate a power plant in a power production mode (e.g., firing mode or fuel combustion mode) to generate electricity and a power consumption mode (e.g., non-firing mode or non-combustion mode) that consumes electricity, wherein a gas treatment system is configured to treat an exhaust gas during the power production mode, and the gas treatment system is configured to treat an airflow during the power consumption mode. During the power production mode, the power plant combusts a fuel to generate a combustion gas as an energy source to drive one or more motor-generators (e.g., operating in an electric generator mode) to generate the electricity, while the gas treatment system removes undesirable gases (e.g., CO₂) from the exhaust gas. For example, the combustion gas may be used to drive a gas turbine of a gas turbine system coupled to a motor-generator and/or the combustion gas may be used to generate steam to drive a steam turbine of a steam turbine system coupled to a motor-generator. During the power consumption mode, the power plant consumes electricity to drive one or more airflows through the gas treatment system, thereby treating the air to reduce the carbon footprint of the power plant. For example, the power plant may consume electricity to operate the motor-generator (e.g., operating in an electric motor mode) to drive a compressor of a gas turbine system, an air mover of a combustion system, and/or one or more additional air movers to provide the one or more airflows through the gas treatment system. In some embodiments, the power plant may consume electricity to drive one or more separate motor driven air movers to provide the one or more airflows through the gas treatment system. Thus, in certain embodiments, the power consumption mode does not include any combustion of fuel to generate electricity, yet the airflows are provided to the gas treatment system for treatment of the air. In certain embodiment, the gas treatment system may include a single gas capture system or a plurality of gas capture systems, wherein the gas treatment system may be configured to use the same or different gas capture systems for treating the exhaust gas in the power production mode and for treating the air in the power consumption mode. Thus, in the present application, any use of the same or different gas capture systems is contemplated for the exhaust gas and air treatment.

As discussed in detail below, the power plant may operate in the power production mode when a power demand and/or energy pricing is above a threshold level, whereas the power plant may operate in the power consumption mode when the power demand and/or energy pricing is below the threshold level (e.g., low or negative energy pricing). The threshold levels may vary depending on a variety of factors, including threshold levels based on operator preferences, emissions standards, or any other factors. In the present application, any discussion of power demand and/or energy pricing as a basis for switching the power plant between the power production mode and the power consumption mode is intended as a non-limiting example. In context of power demand and energy pricing, the power plant can use electricity when the power demand and/or energy pricing is low or negative, thereby providing advantageous environmental benefits by treating the air to reduce undesirable gases (e.g., CO₂) in the environmental air. Collectively, by treating the exhaust gas during the power production mode and by treating the airflow during the power consumption mode, the power plant has an overall emissions level of undesirable gases (e.g., CO₂) that is lower than otherwise possible if only treating exhaust gas during the power production mode. In this manner, the power plant may be more readily capable of achieving a target carbon footprint, such as carbon neutral or carbon negative emissions (e.g., CO₂ emissions) or another suitable target.

In context of exhaust gas treatment, carbon neutral is a state of net-zero CO₂ emissions, wherein the amount of CO₂ in the exhaust gas equals the amount of CO₂ in the inlet air to a process. Similarly, in context of exhaust gas treatment, carbon negative is a state of net-negative CO₂ emissions, wherein the amount of CO₂ in the exhaust gas is less than the amount of CO₂ in the inlet air to a process. In context of air treatment, carbon negative is a state of net-negative CO₂ emissions, wherein the amount of CO₂ in the treated air is less than the amount of CO₂ in the environmental air prior to treatment. In certain embodiments, the power plant enables carbon neutral or carbon negative emissions (e.g., CO₂ emissions) during the power production mode, and the power plant also enable carbon negative emissions (e.g., CO₂ emissions) during the power consumption mode. Collectively, the power plant may enable carbon neutral or carbon negative emissions (e.g., CO₂ emissions) when considering the exhaust gas treatment during the power production mode and the air treatment during the power consumption mode.

Again, in some embodiments, the power plant may not reach carbon neutral or carbon negative emissions; however, the carbon footprint may be substantially reduced by treating exhaust gas (e.g., CO₂ capture) in the power production mode and by treating air (e.g., CO₂ capture) in the power consumption mode. In certain embodiments, the power plant enables a first reduction in emissions (e.g., CO₂ capture) during the power production mode, and the power plant also enables a second reduction in emissions (e.g., CO₂ capture) during the power consumption mode. The first reduction in emissions may, for example, be at least 50, 60, 70, 80, 90, 95, 97.5, 99, or 100 percent carbon capture (e.g., CO₂ capture) from the exhaust gas. The second reduction in emissions may, for example, be at least 50, 60, 70, 80, 90, 95, 97.5, 99, or 100 percent carbon capture (e.g., CO₂ capture) from the environmental air being treated. Collectively, the power plant enables a reduced carbon footprint (e.g., CO₂ emissions) when considering the exhaust gas treatment during the power production mode and the air treatment during the power consumption mode. Accordingly, the following discussion should be understood to cover any reduction in the undesirable gases (e.g., CO₂) benefiting from the air treatment at the power plant, wherein the air treatment may not otherwise occur as the typical goal is treating an exhaust gas while operating the power plant to generate electricity. Additionally, since the gas treatment system of the power plant is used for both exhaust gas treatment and air treatment, the power plant is able to provide air treatment using the same gas treatment system rather than investing in a dedicated air treatment system (e.g., direct air capture (DAC) plant) unrelated to the power plant.

While the disclosed embodiments are illustrated and described in context of CO₂ removal, the disclosed embodiments may be used for the removal of any “undesirable gas” or “undesirable gases,” including but not limited to carbon oxides (e.g., CO₂, CO), nitrogen oxides (e.g., NO₂), sulfur oxides (e.g., SO₂), and various other acid gases and/or greenhouse gases. As discussed below, the combustion systems may be associated with a power plant (e.g., a coal or other fuel fired power plant or a combined cycle power plant), a simple cycle gas turbine system, a reciprocating piston-cylinder engine, a furnace, a boiler, or other industrial equipment that generate exhaust gas. The combined cycle power plant may include a gas turbine system that drives an electrical generator, a heat recovery steam generator (HRSG) that uses heat from the exhaust gas of the gas turbine system to generate steam, and a steam turbine of a steam turbine system driven by the steam to drive an electrical generator. The coal or other fuel fired power plant may use combustion gas from burning fuel (e.g., coal) to generate steam in a steam generator (e.g., boiler), wherein a steam turbine of a steam turbine system is driven by the steam to drive an electrical generator.

With the foregoing in mind, the disclosed embodiments include a plurality of gas treatment stages, which are configured to remove undesirable gases (e.g., CO₂) from the air and/or the exhaust gas of the combustion systems to help achieve a desired target of emission, such as, but not limited to, net neutral or net negative emissions. The disclosed embodiments may use the same or different gas treatment stages (e.g., gas capture stages) for the air treatment and the exhaust gas treatment. Additionally, although the plurality of stages may be used for exhaust gas treatment and air treatment in a variety of configurations, certain embodiments of the gas treatment system may use a single stage of gas treatment (e.g., gas capture). The plurality of gas treatment stages may include one or more gas treatment systems disposed upstream of a compressor and/or combustor, one or more gas treatment systems disposed downstream of a gas turbine and/or the HRSG, or a combination thereof. The gas treatment systems may include sorbent-based gas treatment systems, solvent-based gas treatment systems, cryogenic based gas treatment, one or more other types of gas treatment systems, or a combination thereof. The gas treatment systems are not limited to the examples described herein, and thus any suitable gas treatment systems may be used for gas capture. For example, the sorbent-based gas treatment systems are configured to adsorb the undesirable gases into a sorbent material, and then subsequently desorb the undesirable gases from the sorbent material using a heat source. The adsorption process is exothermic, while the desorption process is endothermic. By further example, the solvent-based gas treatment systems may include an absorber configured to absorb the undesirable gas into a solvent, and a regenerator configured to strip the undesirable gas from the solvent using a heat source. Thus, in both types of gas treatment systems, a heat source may be used to facilitate the removal and capture of the undesirable gases (e.g., CO₂). During the power production mode (e.g., firing mode), the heat source may include steam generated by a steam generator (e.g., HRSG), waste heat from one or more waste heat recovery systems, or a combination thereof. During the power consumption mode (e.g., non-firing mode), the heat source may Include one or more heaters (e.g., electric heaters), heat exchangers, or a combination thereof. In some embodiments, the heat source may include one or more separate gas turbine systems generating heat in the form of exhaust gas, compressed air, and/or waste heat. Additionally, in some embodiments, the heat source may include one or more separate steam generators (e.g., HRSGs), such as associated with the separate gas turbine systems, which are configured to provide steam as the heat source. Various aspects and embodiments of the gas treatment systems are discussed in further detail below.

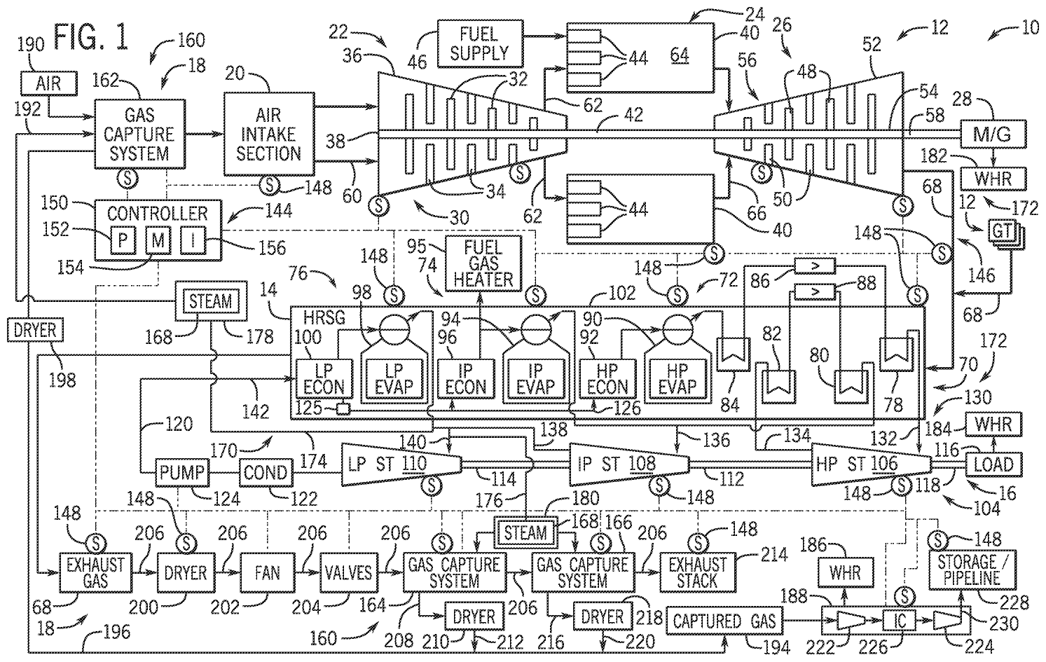

FIG. 1 is a schematic of an embodiment of a combined cycle power plant 10 having a gas turbine system 12 (e.g., gas turbine engine), a heat recovery steam generator (HRSG) 14, a steam turbine system 16 (e.g., steam turbine engine), and a multi-stage gas treatment system (GTS) 18. As discussed in further detail below, the multi-stage gas treatment system 18 is configured to treat one or more airflows and/or exhaust gas in the combined cycle power plant 10. For example, in a power production mode (e.g., firing mode or combustion mode), the combined cycle power plant 10 is configured to treat the exhaust gas resulting from combustion of fuel via the multi-stage gas treatment system 18, while generating electricity for local usage or distribution on a power grid. In a power consumption mode (e.g., non-firing mode or non-combustion mode), the combined cycle power plant 10 is configured to consume electricity to drive one or more airflows for treatment in the multi-stage gas treatment system 18. The power consumption mode is particularly advantageous when the power demand and/or power pricing drops below a threshold, such as a low or negative energy pricing. Collectively, the air treatment during the power consumption mode and the exhaust gas treatment during the power production mode helps to provide a desired reduction in carbon emissions (e.g., carbon neutral or carbon negative emissions (e.g., CO₂ emissions)) by the combined cycle power plant 10. The various features and stages of the gas treatment system 18 are discussed in further detail below, and the various features and stages may be used in any suitable combination with one another. However, before moving on to the gas treatment system 18 and the different modes (e.g., power production mode and power consumption mode), the combined cycle power plant 10 will be described as one possible context for use of the gas treatment system 18.

The gas turbine system 12 cycle is often referred to as the “topping cycle,” whereas the steam turbine system 16 cycle is often referred to as the “bottoming cycle.” By combining these two cycles as illustrated in FIG. 1, the combined cycle power plant 10 may lead to greater efficiencies in both cycles. In particular, exhaust heat from the topping cycle may be captured and used to generate steam in the HRSG 14 for use in the bottoming cycle. However, the HRSG 14 may be configured to generate and supply steam for other uses in the combined cycle power plant 10, including the gas treatment system 18 (e.g., in the power production mode). For example, the gas treatment system 18 may be configured to use steam generated in the HRSG 14 to facilitate the separation and capture of undesirable gases, such as carbon capture (e.g., CO₂ capture) in sorbent-based gas treatment systems and/or solvent-based gas treatment systems. However, in the power consumption mode, the gas treatment system 18 may use other heat sources, such as electric heaters, heat exchangers, waste heat systems, or any combination thereof. During the power consumption mode, the use of heat exchangers and/or waste heat systems may depend on the availability of other heated fluids and/or waste heat.

As illustrated, the gas turbine system 12 includes an air intake section 20, a compressor section 22, a combustor section 24, a turbine section 26, and a motor-generator 28 (e.g., selectively functioning as an electric motor or an electric generator). As discussed in detail below, the motor-generator 28 may operate as the electric generator during the power production mode, whereas the motor-generator 28 may operate as the electric motor during the power consumption mode. The air intake section 20 may include one or more air filters, anti-icing systems, fluid injection systems (e.g., temperature control fluids), silencer baffles, or any combination thereof, which may be disposed in a filter house and/or an air intake duct. The air intake section 20, in some embodiments, may include one or more air movers configured to help induce an airflow through the air intake section 20 and the gas turbine system 12 during the power consumption mode. For example, the air movers may include electric motor driven fans or blowers, which may be activated during the power consumption mode. The compressor section 22 includes multiple compressor stages 30, each having multiple rotating compressor blades 32 coupled to a compressor shaft 38 and multiple stationary compressor vanes 34 coupled to a compressor casing 36. The combustor section 24 includes one or more combustors 40. A shaft 42 extends between the compressor section 22 and the turbine section 26. Each combustor 40 includes one or more fuel nozzles 44 coupled to one or more fuel supplies 46, which may supply fuel through primary and secondary fuel circuits. The fuel supplies 46 may supply natural gas, syngas, biofuel, fuel oils, or any combination of liquid and gas fuels. The turbine section 26 includes multiple turbine stages 56, each having multiple rotating turbine blades 48 coupled to a turbine shaft 54 and multiple stationary turbine vanes 50 coupled to a turbine casing 52. The turbine shaft 54 also connects to the motor-generator 28 via a shaft 58.

In the power production mode, the gas turbine system 12 routes an air intake flow 60 from the air intake section 20 into the compressor section 22. The compressor section 22 progressively compresses the air intake flow 60 in the stages 30 and delivers a compressed airflow 62 into the one or more combustors 40. The one or more combustors 40 receive fuel from the fuel supply 46, route the fuel through the fuel nozzles 44, and combust the fuel with the compressed airflow 62 to generate hot combustion gases in a combustion chamber 64 within the combustor 40. The one or more combustors 40 then route a hot combustion gas flow 66 into the turbine section 26. The turbine section 26 progressively expands the hot combustion gas flow 66 and drives rotation of the turbine blades 48 in the stages 56 before discharging an exhaust gas flow 68. As the hot combustion gas flow 66 drives rotation of the turbine blades 48, the turbine blades 48 drive rotation of the turbine shaft 54, the shafts 42 and 58, and the compressor shaft 38. Accordingly, in the power production mode, the turbine section 26 drives rotation of the compressor section 22 and the motor-generator 28 (e.g., functioning as an electric generator). The exhaust gas flow 68 may be partially or entirely directed to flow through the HRSG 14 to enable heat recovery and steam generation. In certain embodiments, one or more additional gas turbine systems 12 may be included as part of the combined cycle power plant 10, wherein the additional gas turbine systems 12 may discharge exhaust gas flows 68 to the HRSG 14. Thus, the collective exhaust gas flow 68 from the gas turbine systems 14 (e.g., 1, 2, 3, 4, or more) may pass through the HRSG 14 to generate steam for the steam turbine system 16, and the exhaust gas flow 68 is then treated by the gas treatment system 18.

The HRSG 14 may include a plurality of heat exchangers and/or heat exchange components 70 disposed in different sections, such as a high-pressure (HP) section 72, an intermediate-pressure (IP) section 74, and a low-pressure (LP) section 76. The components 70 may include economizers, evaporators, superheaters, or any combination thereof, in each of the HP, IP, and LP sections 72, 74, and 76. The components 70 may be coupled together via various conduits and headers. In the power production mode, the HRSG 14 may route one or more flows of steam (e.g., low-pressure steam, intermediate-pressure steam, and high-pressure steam) to the steam turbine system 16. In the illustrated embodiment, the components 70 of the HRSG 14 include a finishing high-pressure superheater 78, a secondary re-heater 80, a primary re-heater 82, a primary high-pressure superheater 84, an inter-stage attemperator 86, an inter-stage attemperator 88, a high-pressure evaporator 90 (HP EVAP), a high-pressure economizer 92 (HP ECON), an intermediate-pressure evaporator 94 (IP EVAP), an intermediate-pressure economizer 96 (IP ECON), a low-pressure evaporator 98 (LP EVAP), and a low-pressure economizer 100 (LP ECON). The HRSG 14 also includes an enclosure or duct 102 housing the various components 70. The functionality of the components 70 is discussed in further detail below.

The steam turbine system 16 includes a steam turbine 104 having a high-pressure steam turbine (HP ST) 106, an intermediate-pressure steam turbine (IP ST) 108, and a low-pressure steam turbine (LP ST) 110, which are coupled together via shafts 112 and 114. In certain embodiments, the steam turbine system 16 may include any number of steam turbines, such as 1, 2, 3, 4, 5, or more steam turbines. As illustrated, the steam turbine 104 may be coupled to a load 116 (e.g., electric generator) via a shaft 118. In some embodiments, the gas turbine system 12 and the steam turbine system 16 are arranged in series along a common shaft, and thus may both drive the same load (e.g., motor-generator 28). In the power production mode, the HRSG 14 may be configured to generate a high-pressure steam for the high-pressure steam turbine 106, an intermediate-pressure steam for the intermediate-pressure steam turbine 108, and a low-pressure steam for the low-pressure steam turbine 110. In certain embodiments, an exhaust from the high-pressure steam turbine 106 may be routed into the intermediate-pressure steam turbine 108 through the primary re-heater 82, the inter-stage attemperator 88, and the secondary re-heater 80 within the HRSG 14, and an exhaust from the intermediate-pressure steam turbine 108 may be routed into the low-pressure steam turbine 110. The steam turbine 104 may discharge a condensate 120 (or the steam may be condensed in a condenser 122 downstream from the steam turbine 104), such that the condensate 120 can be pumped back into the HRSG 14 via one or more pumps 124.

In the power production mode, the exhaust gas flow 68 passes through the HRSG 14 and transfers heat to the components 70 to generate steam for driving the steam turbine 104. The exhaust steam from the low-pressure steam turbine 110 may be directed into the condenser 122 to form the condensate 120. The condensate 120 from the condenser 122 may, in turn, be directed into the low-pressure section 76 of the HRSG 14 with the aid of the pump 124. The condensate 120 may then flow through the low-pressure economizer 100, which is configured to heat a feedwater 126 (including the condensate 120) with the exhaust gas flow 68. From the low-pressure economizer 100, the feedwater 126 may flow into the low-pressure evaporator 98. The feedwater 126 from low-pressure economizer 100 may be directed toward the intermediate-pressure economizer 96 and the high-pressure economizer 92 with the aid of a pump 125. Steam from the low-pressure evaporator 98 may be directed to the low-pressure steam turbine 110. Likewise, from the intermediate-pressure economizer 96, the feedwater 126 may be routed into the intermediate-pressure evaporator 94 and/or toward the high-pressure economizer 92. In addition, steam from the intermediate-pressure economizer 96 may be routed to a fuel gas heater 95, where the steam may be used to heat fuel gas for use in the combustion chamber 64 of the gas turbine system 12. Steam from the intermediate-pressure evaporator 94 may be routed to the intermediate steam turbine 108.

The feedwater 126 from the high-pressure economizer 92 may be routed into the high-pressure evaporator 90. Steam from the high-pressure evaporator 90 may be routed into the primary high-pressure superheater 84 and the finishing high-pressure superheater 78, where the steam is superheated and eventually routed to the high-pressure steam turbine 106. The inter-stage attemperator 86 may be located in between the primary high-pressure superheater 84 and the finishing high-pressure superheater 78. The inter-stage attemperator 86 may enable more robust control of the exhaust temperature of steam from the finishing high-pressure superheater 78. Specifically, the inter-stage attemperator 86 may be configured to control the temperature of steam exiting the finishing high-pressure superheater 78 by injecting a cooler feedwater spray into the superheated steam upstream of the finishing high-pressure superheater 78 whenever the exhaust temperature of the steam exiting the finishing high-pressure superheater 78 exceeds a predetermined value.

In addition, an exhaust from the high-pressure steam turbine 106 may be directed into the primary re-heater 82 and the secondary re-heater 80, where it may be re-heated before being directed into the intermediate-pressure steam turbine 108. The primary re-heater 82 and the secondary re-heater 80 may also be associated with the inter-stage attemperator 88, which is configured to control the exhaust steam temperature from the re-heaters. Specifically, the inter-stage attemperator 88 may be configured to control the temperature of steam exiting the secondary re-heater 80 by injecting cooler feedwater spray into the superheated steam upstream of the secondary re-heater 80 whenever the exhaust temperature of the steam exiting the secondary re-heater 80 exceeds a predetermined value. The arrangement of the components 70 of the HRSG 14 is merely one possible example for use with the combined cycle power plant 10 and the gas treatment system 18, and the components 70 may be arranged differently within the scope of the present disclosure.

The combined cycle power plant 10 further includes a fluid connection system 130 between stages of the HRSG 14 and stages of the steam turbine system 16. For example, the fluid connection system 130 includes a high-pressure steam supply conduit or line 132 coupled to the finishing high-pressure superheater 78 and an inlet into the high-pressure steam turbine 106, and a discharge or return line 134 coupled to an outlet of the high-pressure steam turbine 106 and the primary re-heater 82. The fluid connection system 130 also includes an intermediate-pressure steam supply conduit or line 136 and a discharge or return line 138. The intermediate-pressure steam supply line 136 is fluidly coupled to outlets of the intermediate-pressure evaporator 94 and the secondary re-heater 80 and an inlet into the intermediate-pressure steam turbine 108. The discharge or return line 138 is fluidly coupled to an outlet of the intermediate-pressure steam turbine 108 and an inlet into the low-pressure steam turbine 110. The fluid connection system 130 also includes a low-pressure steam supply conduit or line 140 and a discharge or return line 142. The low-pressure steam supply line 140 is fluidly coupled to outlets of the low-pressure evaporator 98 and the discharge or return line 138 from intermediate-pressure steam turbine 108 and to an inlet into the low-pressure steam turbine 110. The discharge or return line 142 is fluidly coupled to an outlet of the low-pressure steam turbine 110 and an inlet into the low-pressure economizer 100. As discussed above, the return line 142 includes the condenser 122 and the pump 124.

The combined cycle power plant 10 may include a control system 144 communicatively coupled with a monitoring system 146, wherein the control system 144 and the monitoring system 146 are communicatively coupled with various components of the gas turbine system 12, the HRSG 14, the steam turbine system 16, and the gas treatment system 18. The monitoring system 146 is configured to monitor a plurality of sensors 148, designated as “S”, distributed throughout the combined cycle power plant 10. The control system 144 includes a controller 150, wherein the controller 150 includes one or more processors 152, memory 154, and instructions 156 stored on the memory 154 and executable by the processor(s) 152 to perform various control functions for operating the gas turbine system 12, the HRSG 14, the steam turbine system 16, and the gas treatment system 18. In certain embodiments, the control system 144 may communicate information (e.g., sensor feedback, alerts, alarms, etc.) to a user interface, cloud storage, a remote computer system, or any combination thereof.

The sensors 148 may be communicatively coupled to the control system 144 via communication wires or wireless communication circuitry. The sensors 148 may be disposed at one or more locations in the air intake section 20, the compressor section 22, the combustor section 24, the turbine section 26, the HRSG 14, the steam turbine system 16, the gas treatment system 18, and in the surrounding environment (e.g., air quality monitoring). For example, the sensors 148 may be disposed at one or more locations in each of the high-pressure steam turbine 106, the intermediate-pressure steam turbine 108, and the low-pressure steam turbine 110, thereby enabling monitoring of steam properties (e.g., temperature, pressure, etc.) at the various locations. The sensors 148 also may be disposed along each of the lines 132, 134, 136, 138, 140, and 142 of the fluid connection system 130, thereby helping to monitor various fluid parameters between the HRSG 14, the steam turbines 106, 108, and 110, and the gas treatment system 18. Additionally, the sensors 148 may be coupled to and/or distributed throughout the gas treatment system 18 to enable monitoring and control of the gas treatment (e.g., gas capture) from various airflows and/or exhaust gas flows. In certain embodiments, the sensors 148 may include flow sensors, pressure sensors, temperature sensors, fluid composition sensors, flame sensors, vibration sensors, clearance sensors, trip sensors, or any combination thereof. The fluid composition sensors may monitor composition levels of various undesirable gases, such as composition levels of carbon oxides (e.g., CO₂, CO), nitrogen oxides (e.g., NO₂), sulfur oxides (e.g., SO₂), and various other acid gases and/or greenhouse gases as well as oxygen, hydrogen and unreacted fuel gas content. Accordingly, the sensor feedback from the sensors 148 may be used to adjust various aspects of the gas treatment system 18 in the power production mode and the power consumption mode to reduce the carbon footprint of the combined cycle power plant 10, such as by substantially removing undesirable gases (e.g., CO₂) from the exhaust gas and the air (e.g., environmental air), such that the carbon footprint is at least below a desired carbon emissions threshold (e.g., at least a low carbon, a carbon neutral, or carbon negative emissions). Additional details of the monitoring and control of the gas treatment system 18 are discussed further below.

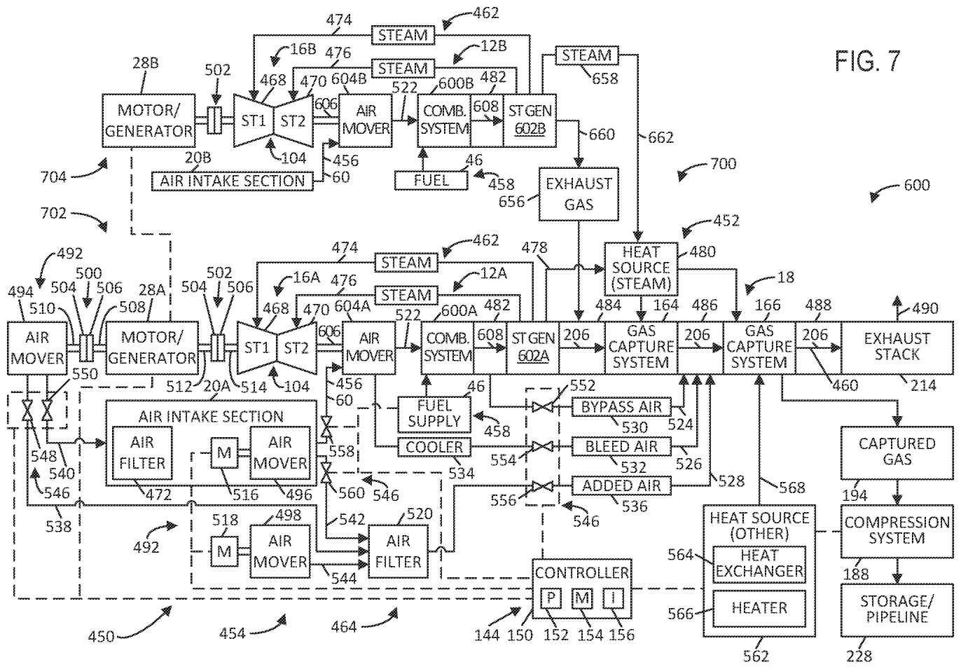

As discussed in further detail below, the gas treatment system 18 is configured to remove and/or capture one or more undesirable gases (e.g., exhaust emissions gases, acid gases, greenhouse gases, etc.) from one or more airflows and/or exhaust gas flow 68 during the power production mode and the power consumption mode of the combined cycle power plant 10. For example, during the power production mode, the gas treatment system 18 is configured to remove and/or capture one or more undesirable gases from an air intake flow 60 into the gas turbine system 12 (e.g., upstream of the compressor section 22 and/or combustor section 24) and/or the exhaust gas flow 68 (e.g., downstream from the turbine section 26 and/or the HRSG 14). By further example, during the power consumption mode, the gas treatment system 18 is configured to remove and/or capture one or more undesirable gases from one or more airflows, which may flow internally through the gas turbine system 12 (e.g., compressor section 22, combustor section 24, and turbine section 26), complete external to the gas turbine system 12, or partially internal and partially external to the gas turbine system 12 (e.g., through compressor section 22 but not through combustor section 24 and/or turbine section 26) using compressor bleed lines extending to the gas treatment system 18. Various air circuits are discussed in further detail below with reference to FIGS. 7. During the power consumption mode, the gas treatment system 18 may not treat any exhaust gas flow 68; however, some embodiments may route an exhaust gas flow from another source to the gas treatment system 18 for treatment along with the airflows.

The undesirable gases are intended to cover any gases that may be undesirable in the environmental air, the air intake flow 60, and/or exhaust gas flow 68. For example, the undesirable gases may include acid gases and/or greenhouse gases. By further example, the undesirable gases may include any gases typically subject to regulation, including but not limited to, carbon oxides (CO_{X}) such as carbon dioxide (CO₂) and carbon monoxide (CO), nitrogen oxides (NO_{X}), sulfur oxides (SO_{X}) such as sulfur dioxide (SO₂), methane (CH₄) or any combination thereof. The disclosed embodiments are particularly well suited for gas adsorption or absorption of CO₂ from the environmental air, the air intake flow 60, and/or exhaust gas flow 68. However, the following discussion is intended to cover each of these examples when referring to undesirable gases.

The gas treatment system 18 may include a plurality of gas capture systems 160 (e.g., gas capture systems 162, 164, and 166) disposed throughout the combined cycle power plant 10 to treat a gas flow (e.g., airflow, exhaust flow, etc.). Each of the gas capture systems 160 (e.g., 162, 164, and 166) may be configured to use one or more heat sources to facilitate gas capture, wherein the gas capture systems 160 may include sorbent-based gas capture systems, solvent-based gas capture systems, or a combination thereof. As discussed below, the heat sources may include heated fluid 168 (e.g., steam and/or heated water) extracted from the HRSG 14 and/or the steam turbine system 16 and supplied to the gas capture systems 160 via a steam supply system 170 (e.g., steam supply circuit), waste heat recovered by a waste heat recovery (WHR) system 172 of the combined cycle power plant 10, one or more electric heaters, or a combination thereof. The HSRG 14 and the waste heat recovery system 172 may be generally available during the power production mode of the combined cycle power plant 10; however, the HRSG 14 and some of the waste heat recovery systems 172 may be unavailable for the power consumption mode of the combined cycle power plant 10. For example, during the power consumption mode, the heat sources may include electric heaters, which may be used to provide heat to generate the heated fluid 168 and/or provide heat in a different manner. For example, the electric heaters may be configured to apply heat directly to the gas capture systems 162, 164, and 166, such as by directly heating sorbent materials and/or solvents. In the present application, any discussion of the heated fluid 168 for use as a heat source for the gas capture systems 162, 164, and 166 is intended to include embodiments relying on electric heaters or other heat sources available during the power consumption mode. For example, the power consumption mode also may use heat exchangers and/or waste heat recovery systems 172, depending on the availability of heated fluids and/or waste heat.

In the power production mode, the gas treatment system 18 may use steam and/or waste heat as a heat source as discussed below. The steam supply system 170 may include steam supply conduits or lines 174 and 176 coupled to the HRSG 14 and/or the steam turbine system 16 at one or more locations. In the illustrated embodiment, the steam supply lines 174 and 176 may be coupled to the HRSG 14 and/or the steam turbine system 16 at or between low-pressure sections and intermediate-pressure sections, such as between the low-pressure steam turbine 110 and the intermediate-pressure steam turbine 108 and/or between the LP section 76 and the IP section 74 of the HRSG 14. However, in certain embodiments, the steam supply system 170 may be selectively coupled to any one, multiple, or all of the components of the HRSG 14 (e.g., one or more components or locations in each of the HP, IP, and LP sections 72, 74, and 76), and/or any one, multiple, or all stages of the steam turbine system 16 (e.g., HP, IP, and LP steam turbines 106, 108, and 110), such that the heated fluid 168 (e.g., steam and/or heated water) can be extracted at one or more pressures, temperatures, or conditions for use in the gas capture systems 160. For example, the control system 144 may be configured to control various valves coupled to steam lines to control steam flow from the various components of the HRSG 14 and the stages of the steam turbine system 16. Additionally, in certain embodiments, the heated fluid 168 (e.g., steam and/or heated water) may be extracted from other sources, such as a waste heat steam generator using waste heat from the waste heat recovery system 172 to generate steam. The gas treatment system 18, via control by the control system 144, is also configured to combine the steam 18 from various steam sources (e.g., HRSG 14, steam turbine system 16, waste heat recovery system 172, waste heat steam generator, etc.) to provide a mixed steam with desired steam characteristics, e.g., steam temperature and associated pressure between upper and lower temperature thresholds. In addition, the quality of the steam (saturated or superheated) can be monitored to meet specific heating requirements of the gas treatment system 18.

The control system 144 and the monitoring system 146 are communicatively coupled to the gas treatment system 18, including the various gas capture systems 160, to provide control of the gas treatment and capture processes, including control of the heat sources (e.g., the heated fluid 168, waste heat, electric heaters, etc.) being used by the gas capture systems 160. The heat source may depend on the mode of the combined cycle power plant 10. For example, in the power consumption mode of the combined cycle power plant 10, the heated fluid 168 may be unavailable, and thus the gas treatment system 18 may rely on one or more electric heaters as a heat source. However, when the heated fluid 168 is available, such as during the power production mode of the combined cycle power plant 10, the steam can be applied to the gas treatment system 18 as indirect heating through a heat exchanger process or direct heating of the CO₂ loaded sorbent or solvent. If the monitoring system 146 (e.g., sensors 148) indicates that the temperature of the extracted heated fluid 168 (e.g., steam and/or heated water) is above an upper temperature threshold, then the control system 144 may be configured to control the gas treatment system 18 to attemperate or cool the heated fluid 168 (e.g., via attemperator, cooler, or heat exchanger) to lower the steam temperature to be within upper and lower temperature thresholds. If the monitoring system 146 (e.g., sensors 148) indicates that the temperature of the extracted heated fluid 168 (e.g., steam and/or heated water) is below a lower temperature threshold, then the control system 144 may be configured to control the gas treatment system 18 to heat the heated fluid 168 (e.g., via heater or heat exchanger) to increase the steam temperature to be within the upper and lower temperature thresholds. In certain embodiments, the upper and lower temperature thresholds may be approximately 80 to 120 degrees Celsius for the gas capture systems 160 using sorbent-materials (e.g., sorbent-based gas capture systems).

For temperature adjustments, the steam supply lines 174 and 176 may include respective heat exchangers 178 and 180 configured to adjust the heated fluid 168 (e.g., steam and/or heated water) being supplied to the gas capture systems 160. The heat exchangers 178 and 180 may use another fluid to heat or cool the steam. For example, the waste heat recovery system 172 may be configured to exchange heat (e.g., via heat exchange fluids) with the heat exchangers 178 and 180 to heat or cool the heated fluid 168 (e.g., steam and/or heated water) to be within the upper and lower temperature thresholds. The control system 144 may be coupled to various valves, pressure regulators, and sensors 148 to help control the respective flows through the heat exchangers 178 and 180, thereby controlling the heat exchange and resulting temperatures of the heated fluid 168 (e.g., steam and/or heated water). Additionally or alternatively, as noted above, the waste heat recovery system 172 may be configured to transfer heat between the waste heat and the heated fluid 168 (e.g., steam and/or heated water), such as in a waste heat steam generator, to adjust the temperature of the heated fluid 168. The waste heat recovery system 172 also may be used to improve the efficiency of the combined cycle power plant 10 in other ways, such as by providing heat to other equipment throughout the combined cycle power plant 10.

The waste heat recovery system 172 may include a plurality of distributed waste heat recovery systems 182, 184, and 186. The waste heat recovery system 182 is coupled to the motor-generator 28 (e.g., electrical generator) of the gas turbine system 12, the waste heat recovery system 184 is coupled to the load 116 (e.g., electrical generator) of the steam turbine system 16, and the waste heat recovery system 186 is coupled to a compression system 188 of the gas treatment system 18. The waste heat recovery systems 182, 184, and 186 may include one more heat exchangers configured to transfer heat between the respective heat generating components (e.g., 28, 116, and 188) and one or more fluids. For example, each waste heat recovery systems 182, 184, and 186 may transfer heat between a first fluid (e.g., a coolant and/or lubricant in the heat generating components 28, 116, and 188) and a second fluid via a first heat exchanger. The second fluid may be water used directly to generate steam in a waste heat steam generator, or a working fluid used indirectly to transfer heat to water (e.g., via a second heat exchanger) to generate steam. In some embodiments, the waste heat recovery system 172 may include one or more distributed waste heat recovery systems coupled to other machinery and equipment in the combined cycle power plant 10, including but not limited to electric motors, pumps, compressors, chemical reactors, air separation units (ASUs), or any combination thereof. In some embodiments, the waste heat recovery system 172 may be configured to convey a heated fluid (e.g., water, coolant, lubricant, etc.) to provide heat to the gas capture systems 160, wherein the heated fluid may be used alone or in combination with the heated fluid 168 (e.g., steam and/or heated water) as the heat source for the gas capture systems 160. Again, if the foregoing heat sources are unavailable, such as during the power consumption mode of the combined cycle power plant 10, one or more electric heaters may be used as a heat source to support the gas treatment system 18.

In certain embodiments, the gas capture systems 160 (e.g., 162, 164, and 166) may be arranged in series (e.g., multiple stages), in parallel, or a combination thereof, relative to a direction of flow through the combined cycle power plant 10. However, the illustrated embodiment includes at least two of the gas capture systems 160 arranged in series, such that multiple stages of gas capture help to sequentially reduce the content of undesirable gases to a desired gas capture threshold (e.g., a low carbon, a net neutral, or a net negative capture status). For example, the gas treatment system 18 may include or selectively operate: only a plurality of the gas capture system 162, only a plurality of the gas capture system 164, only a plurality of the gas capture system 166, a combination with the gas capture systems 162 and 164, a combination with the gas capture systems 162 and 166, a combination with the gas capture systems 164 and 166, all of the gas capture systems 162, 164, and 166, or any suitable multi-stage arrangement of 2, 3, 4, 5, 6, 7, 8, 9, 10, or more gas capture systems 160. Additionally, the multi-stage gas treatment system 18 may include the same or different gas capture systems 160 at the various locations, such as different sizes or flow capacities, different internal surface areas along the flow paths, different flow rates along the flow paths, different numbers of flow paths, different geometries or tortuous configurations of the flow paths, different residence times along the flow paths, different gas capture technologies (e.g., sorbent-based gas capture and/or solvent-based gas capture), specifications to handle high or low concentrations of undesirable gases, or any combination thereof. For example, the gas capture systems 162 and 166 may be designed to handle low concentrations of undesirable gases, whereas the gas capture system 164 may be designed to handle high concentrations of undesirable gases. In some embodiments, the concentration of undesirable gases in gas capture systems 162 and 166 may be more than 100 times lower than in gas capture system 164.

The gas capture systems 162, 164, and 166 may differ in design and gas treatment capacities at least partially due to their placements in the combined cycle power plant 10. In the illustrated embodiment, the gas capture system 162 is coupled to the combined cycle power plant 10 along the air intake flow 60 (e.g., at the air intake section 20), while the gas capture systems 164 and 166 are coupled to the combined cycle power plant 10 along the exhaust gas flow 68 (e.g., downstream from the turbine section 26). However, the gas capture systems 164 and 166 may be selectively operated either for gas treatment of the exhaust gas flow 68 during the power production mode, or for gas treatment of an airflow during the power consumption mode. In certain embodiments, during the power consumption mode, any one or more of the gas capture systems 162, 164, and/or 166 may be used to treat airflows and capture undesirable gases (e.g., CO₂).

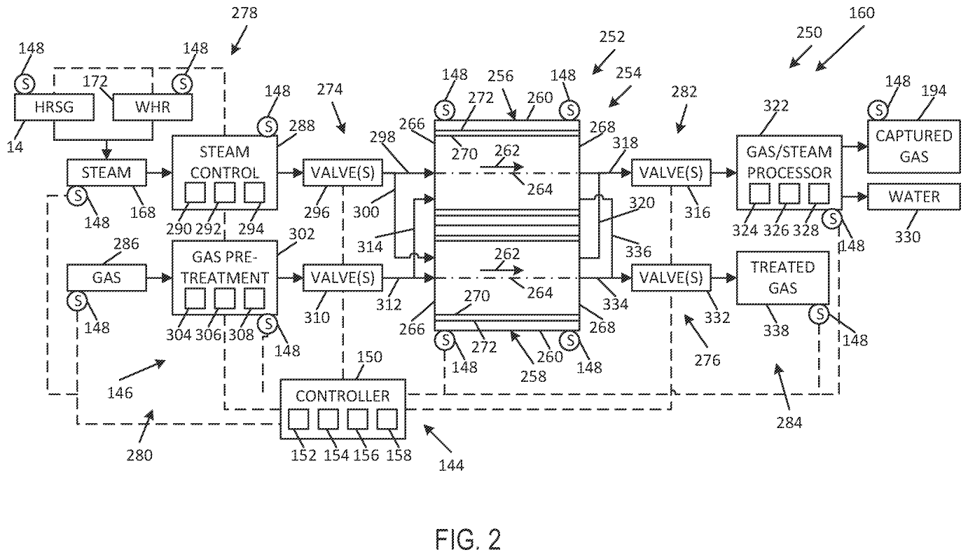

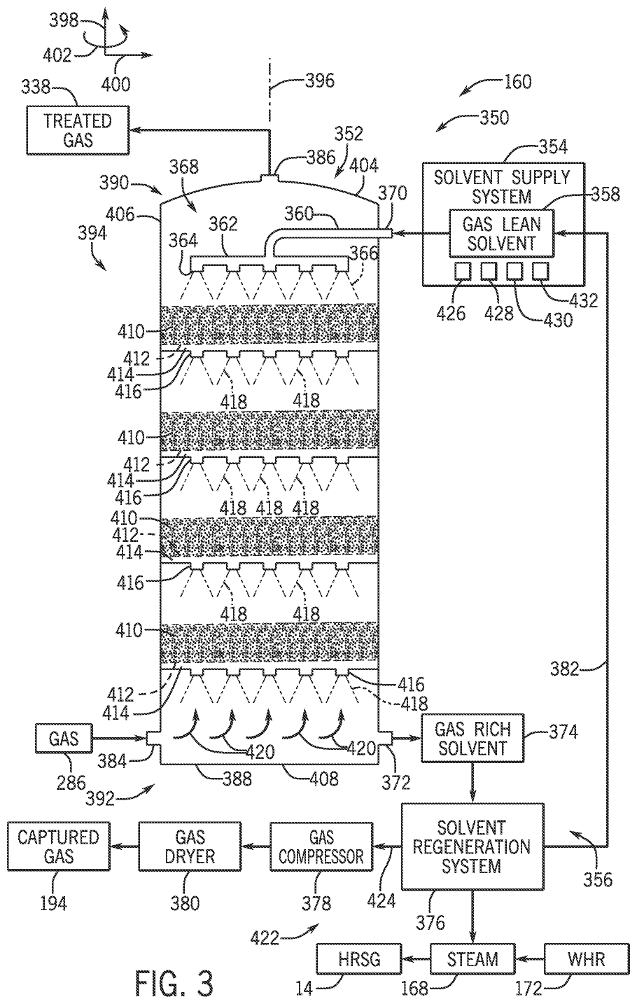

In the illustrated embodiment, the gas capture system 162 is configured to capture undesirable gases (e.g., CO₂) from a flow of air (airflow) 190 prior to entry and/or combustion in the gas turbine system 12. In the power production mode, the gas capture system 162 uses the heated fluid 168 (e.g., steam and/or heated water) as a heat source; however, in the power consumption mode, the gas capture system 162 may use one or more electric heaters as a heat source. As discussed in further detail below, the gas capture system 162 may include a sorbent-based gas capture system, a solvent-based gas capture system, or a combination thereof. Examples are presented below with reference to FIGS. 2 and 3. The steam supply line 174 is coupled to the gas capture system 162, and provides the heated fluid 168 (e.g., steam and/or heated water) as a steam flow and/or water flow as indicated by arrow 192. As discussed above, the steam supply system 170 may include one or more steam supply lines (e.g., line 174) coupled to the HRSG 14 and/or the steam turbine system 16 at one or more locations, such that the heated fluid 168 (e.g., steam and/or heated water) can be supplied to the gas capture system 162 at a variety of conditions (e.g., pressures, temperatures, steam content, water content, etc.).

Although illustrated at the air intake section 20, the gas capture system 162 may be configured to treat an airflow 190 at any location throughout the combined cycle power plant 10, including airflows upstream from the compressor section 22, between compressor stages 30 of the compressor section 22, downstream from the compressor section 22 and upstream from the combustor section 24, other locations including airflows, or a combination thereof. In certain embodiments, the gas capture system 162 may be configured to treat a recirculated exhaust gas (EGR), such as the exhaust gas 68 recirculated into the compressor section 22, and thus the gas capture system 162 may be sized to handle greater concentrations of undesirable gases that are recirculated as part of the EGR process. The gas capture system 162 generally treats the airflow 190 (or EGR flow) directed into the gas turbine system 12, such that the concentration of undesirable gases is low, while also routing a captured gas 194 to the compression system 188 via a discharge conduit or line 196. The discharge line 196 also may include post-processing equipment, such as a dryer 198 configured to remove moisture content from the captured gas 194.

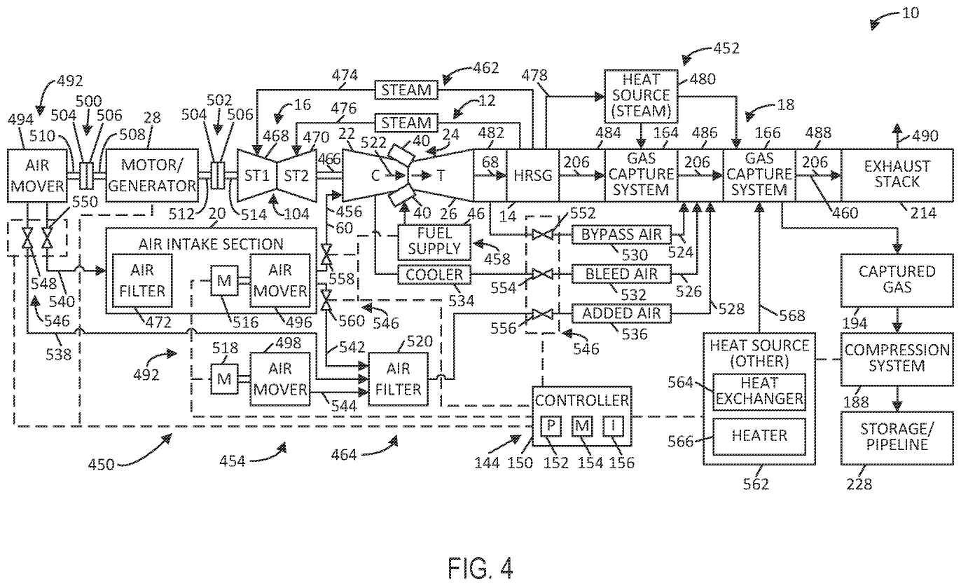

As further illustrated in FIG. 1, the gas capture systems 164 and 166 are coupled to the combined cycle power plant 10 along the exhaust gas flow 68 downstream from the gas turbine section 26 and the HRSG 14. In the power production mode of the combined cycle power plant 10, the gas capture systems 164 and 166 are configured to remove undesirable gas from the exhaust gas flow 68 discharged from the gas turbine system 12 and the HRSG 14. In certain embodiments, the gas capture systems 164 and 166 may be configured to treat an exhaust gas flow at any location throughout the combined cycle power plant 10, including exhaust gas flows upstream from the HRSG 14, between sections (e.g., HP, IP, and LP sections 72, 74, and 76) of the HRSG 14, downstream from the HRSG 14, independent exhaust gas flows relative to the exhaust gas flow 68, or any combination thereof. For example, the independent exhaust gas flows may originate from other combustion systems, such as furnaces, boilers, reciprocating piston-cylinder engines, or any combination thereof. In the illustrated embodiment, the gas capture system 164 is disposed upstream from the gas capture system 166, such that the gas capture systems 164 and 166 may represent first and second gas capture stages along the exhaust gas flow 68. In the power consumption mode of the combined cycle power plant 10, one or both of the gas capture systems 164 and 166 may be used to treat an airflow while the combustion does not occur in the gas turbine system 12. For example, as discussed below with reference to FIGS. 4-7, the airflow may be routed internally through the gas turbine system 12, externally from the gas turbine system 12, and/or partially internal and partially external to the gas turbine system 12, such that the airflow is driven through one or both of the gas capture systems 164 and 166 to remove undesirable gases (e.g., CO₂) from the air.

As further illustrated in FIG. 1, the gas treatment system 18 may include one or more dryers 200, one or more fans 202, and one or more valves 204 along a flow path (e.g., duct) 206 upstream from the gas capture systems 164 and 166. In the power production mode, the flow path 206 corresponds to an exhaust flow path of the exhaust gas flow 68. In the power consumption mode, the flow path 206 may correspond to an airflow path of an airflow, such as an airflow that passes internally through the gas turbine system 12. The one or more dryers 200 are configured to remove moisture (e.g., water content or steam) and dry the exhaust gas flow 68 and/or airflow along the flow path 206. The one or more fans 202 (e.g., electric motor driven fans) are configured to boost a pressure and/or flow rate of the exhaust gas flow 68 and/or airflow along the flow path 206. The one or more valves 204 are configured to adjust a pressure, flow rate, and/or distribution of the exhaust gas flow 68 and/or airflow along the flow path 206 into the gas capture systems 164 and 166. In certain embodiments, the illustrated dryers 200, fans 202, and valves 204 are partially or entirely shared by the gas capture systems 164 and 166. However, in some embodiments, one or more dryers 200, fans 202, and valves 204 may be disposed independently upstream of each of the gas capture systems 164 and 166. Depending on the mode (e.g., power production mode or power consumption mode) of the combined cycle power plant, the exhaust gas flow 68 and/or airflow along the flow path 206 flows through each of the gas capture systems 164 and 166 in series for staged removal of the undesirable gases to achieve desired capture amounts. For example, in the power production mode, the exhaust gas flow 68 flows through both of the gas capture systems 164 and 166. In the power consumption mode, the airflow may flow through only the gas capture system 164, only the gas capture system 166, or both of the gas capture systems 164 and 166. In some embodiments, the gas capture system 166 may be designed for lower concentrations of the undesirable gases (e.g., CO₂), and thus the gas capture system 166 may be more suitable for treating the airflow in the power consumption mode.

In the power production mode of the combined cycle power plant 10, the gas capture system 164 removes a portion of the undesirable gases from the exhaust gas flow 68, discharges a treated exhaust gas flow (e.g., upstream or first stage treated exhaust gas) to the gas capture system 166, and discharges a captured gas portion of the captured gas 194 as indicated by discharge conduit or line 208. As discussed in further detail below, the gas capture system 164 may include a sorbent-based gas capture system, a solvent-based gas capture system, or a combination thereof. Examples are presented below with reference to FIGS. 2 and 3. The steam supply line 176 is coupled to the gas capture system 164, and provides the heated fluid 168 (e.g., steam and/or heated water) as a steam flow and/or a heated water flow into the gas capture system 164. As discussed above, the steam supply system 170 may include one or more steam supply lines (e.g., line 176) coupled to the HRSG 14 and/or the steam turbine system 16 at one or more locations, such that the heated fluid 168 (e.g., steam and/or heated water) can be supplied to the gas capture system 164 at a variety of conditions (e.g., pressures, temperatures, steam content, water content, etc.). The discharge line 208 may include a variety of post-processing equipment, such as a dryer 210 configured to remove moisture (e.g., water content or steam) and dry the captured gas 194 to generated dried captured gas as indicated by discharge conduit or line 212. The captured gas 194 then flows to the compression system 188 as discussed below. In the power consumption mode, the gas capture system 164 may selectively remove a portion of the undesirable gases from the airflow, discharges a treated airflow (e.g., upstream or first stage treated airflow) to the gas capture system 166, and discharges a captured gas portion of the captured gas 194 as indicated by discharge conduit or line 208. The heat source used during the power consumption mode may include one or more different heat sources, such as electric heaters and/or heat exchangers.

Similarly, in the power production mode of the combined cycle power plant 10, the gas capture system 166 removes a portion of the undesirable gases from the exhaust gas flow 68, discharges a treated exhaust gas flow (e.g., downstream or second stage treated exhaust gas) to a subsequent gas capture system or an exhaust stack 214, and discharges a captured gas portion of the captured gas 194 as indicated by discharge conduit or line 216. As discussed in further detail below, the gas capture system 166 may include a sorbent-based gas capture system, a solvent-based gas capture system, or a combination thereof. Examples are presented below with reference to FIGS. 2 and 3. The steam supply line 176 is coupled to the gas capture system 166, and provides the heated fluid 168 (e.g., steam and/or heated water) as a steam flow and/or a heated water flow into the gas capture system 166. As discussed above, the steam supply system 170 may include one or more steam supply lines (e.g., line 176) coupled to the HRSG 14 and/or the steam turbine system 16 at one or more locations, such that the heated fluid 168 (e.g., steam and/or heated water) can be supplied to the gas capture system 166 at a variety of conditions (e.g., pressures, temperatures, steam content, water content, etc.). The discharge line 216 may include a variety of post-processing equipment, such as a dryer 218 configured to remove moisture (e.g., water content or steam) and dry the captured gas 194 to generated dried captured gas as indicated by discharge conduit or line 220. The captured gas 194 then flows to the compression system 188 as discussed below. In the power consumption mode, the gas capture system 166 may selectively remove a portion of the undesirable gases from the airflow, discharges a treated airflow (e.g., downstream or second stage treated airflow) to a subsequent gas capture system or an exhaust stack 214, and discharges a captured gas portion of the captured gas 194 as indicated by discharge conduit or line 216. The heat source used during the power consumption mode may include one or more different heat sources, such as electric heaters and/or heat exchangers.

The compression system 188 may include a single stage or multistage compression system. In the illustrated embodiment, the compression system 188 includes one or more first or upstream compressors 222 configured to compress the captured gas 194 in one or more upstream stages, one or more second or downstream compressors 224 configured to compress the captured gas 194 after compression by the compressors 222, and one or more intercoolers 226 configured to cool the captured gas 194 between the compressors 222 and 224. The intercoolers 226 may include heat exchangers, gas dryers, and/or other equipment to facilitate the gas compression. The compression system 188 outputs a compressed captured gas 194 to a storage unit and/or pipeline 228 at a specified pressure and gas purity, as indicated by discharge conduit or line 230. As discussed above, the waste heat recovery system 186 may be coupled to the compression system 188 to extract waste heat used as a heat source for the gas treatment system 18 (e.g., gas capture systems 160), improved plant efficiency, or other uses. The waste heat recovery system 186 may be coupled to one or more of the compressors 222, the compressors 224, and/or the intercoolers 226.

As discussed above, the gas capture systems 162, 164, and 166 may differ due to their placements in the combined cycle power plant 10. For example, the gas capture system 162 may be designed to handle low concentrations of undesirable gases, such as concentrations of CO₂ at or near typical atmospheric concentration levels, thereby ensuring that the gas capture system 162 is configured to reduce the concentration of CO₂ to levels below the typical atmospheric concentration levels (e.g., below about 420 ppmv of CO₂). For example, the gas capture system 162 may be configured to reduce the concentration of CO₂ by at least 50, 60, 70, 80, or 90 percent of the typical atmospheric concentration levels. In certain embodiments, to achieve such concentration levels, the gas capture system 162 may be sized substantially larger than the gas capture systems 164 and 166 to enable sufficient resident time of the gas (e.g., air being treated within the gas capture system 162). In certain embodiments, the gas capture system 162 may be excluded from the gas treatment system 18.

In contrast, the gas capture system 164 may be designed to handle high concentrations of undesirable gases relative to the gas capture systems 162 and/or 166, while the gas capture system 166 may be designed to handle low or intermediate concentrations of undesirable gases relative to the gas capture systems 162 and/or 164. For example, the gas capture system 164 may be designed to handle concentrations of CO₂ of at least 10, 20, 30, 40, 50, 60, 70, 80, 90, 100, 110, 120, 130, 140, 150, or more times greater than the gas capture system 162, whereas the gas capture system 166 may be designed to handle concentrations of CO₂ of at least 2, 3, 4, 5, 6, 7, 8, 9, 10, or more times greater than the gas capture system 162. By further example, the gas capture system 164 may be designed to handle concentrations of CO₂ of at least 10, 11, 12, 13, 14, 15, 16, 17, 18, 19, 20, 21, 22, 23, 24, 25, or more times greater than the gas capture system 166. By further example, the gas capture system 166 may be designed to handle concentrations of CO₂ of at least 1, 2, 3, 4, 5, 6, 7, 8, 9, 10, or more percent relative to the concentrations of CO₂ handled by the gas capture system 162. In one embodiment, in the power production mode of the combined cycle power plant 10, the gas capture systems 164 and 166 may capture approximately 95 percent and 4.5 percent, respectively, of a total concentration of CO₂ in the exhaust gas flow 68, leaving a remaining 0.5 percent for discharge to the exhaust stack 214. In another embodiment, the gas capture systems 164 and 166 may capture approximately 90 percent and 9.5 percent, respectively, of a total concentration of CO₂ in the exhaust gas flow 68, leaving a remaining 0.5 percent for discharge to the exhaust stack 214. Thus, in the power consumption mode, embodiments of the gas capture systems 162 and/or 166 may be suitable for the lower concentrations of undesirable gases (e.g., CO₂) present in the air, as opposed to the higher concentrations of undesirable gases present in the exhaust gas flow 68.

In certain embodiments, the gas capture system 164 may be designed to handle inlet CO₂ concentrations of about 60,000 ppmw (parts per million by weight) (e.g., capture at least 70, 75, 80, 85, 90, 95 or more percent of the CO₂), whereas the gas capture system 162 may be designed to handle inlet CO₂ concentrations of about 643 ppmw (e.g., capture at least 50, 60, 70, 80, or more percent of the CO₂), and whereas the gas capture system 166 may be designed to handle inlet CO₂ concentrations of about 3,000 ppmw (e.g., capture at least 50, 60, 70, 80, 90 or more percent of the CO₂). In certain embodiments, the gas capture system 164 may be designed to capture about 25,000 to 100,000 ppmw of CO₂, whereas the gas capture system 162 may be designed to capture about 100 to 300 ppmv of CO₂, and whereas the gas capture system 166 may be designed to capture about 1,000 to 10,000 ppmw of CO₂. In some embodiments, the gas capture system 164 may be designed to capture at least 70, 75, 80, 85, 90, 95, or greater percent of a total CO₂ concentration in the exhaust gas flow 68, while the gas capture systems 162 and/or 166 may be designed to capture substantially all or part of the remaining CO₂ otherwise present in the exhaust gas flow 68 (e.g., at least 70, 80, 85, 90, or 95 percent of the remaining CO₂). The carbon capture by the gas capture system 162, which removes undesirable gases (e.g., CO₂) from the air intake flow 60, indirectly reduces the presence of the undesirable gases in the exhaust gas flow 68. Again, in the power consumption mode, embodiments of the gas capture systems 162 and/or 166 may be suitable for the lower concentrations of undesirable gases (e.g., CO₂) present in the air, as opposed to the higher concentrations of undesirable gases present in the exhaust gas flow 68.

In one particular embodiment, the gas capture system 164 may be designed to capture approximately 95 percent of a total CO₂ concentration in the exhaust gas flow 68 (e.g., 95 percent of 60,000 ppmw, resulting in gas capture of 57,000 ppmw of CO₂), while the gas capture systems 162 and/or 166 may be designed to capture substantially all or part of the remaining 5 percent of the total CO₂ concentration in the exhaust gas flow 68 (e.g., 2.5, 3, 3.5, 4, 4.5, or 5 percent of 60,000 ppmw, resulting in partial or complete capture of another 3,000 ppmw of CO₂). For example, the gas capture systems 162 and/or 166 may capture 90 percent of the remaining 5 percent (or effectively 4.5 percent) of the total CO₂ concentration (e.g., 90 percent of 3,000 ppmw of CO₂), resulting in only 300 ppmw of CO₂ in the treated exhaust gas flow 68 delivered to the exhaust stack 214. This particular embodiment would result in a net negative carbon footprint for the combined cycle power plant 10. However, a variety of configurations of the gas capture systems 160 (e.g., 162, 164, and 166) are contemplated by the present disclosure in order to achieve a desired carbon footprint (e.g., a low carbon, a net neutral, or a net negative carbon footprint) for the combined cycle power plant 10.

In some embodiments, each of the gas capture systems 162, 164, and 166 may include a number of modular gas capture units, wherein each of the modular gas capture units has a common capacity, and the number of modular gas capture units is selected based on the concentration levels (e.g., CO₂ levels) in the gas being treated at the particular gas capture system 162, 164, or 166. The modular gas capture units also may include modular sorbent-based gas capture units, modular solvent-based gas capture units, or a combination thereof. In this manner, the gas capture systems 162, 164, and 166 may be assembled and scaled to demands of a particular location and application, using the same or different types of gas capture technologies.

As discussed above, the control system 144 and the monitoring system 146 are communicatively coupled to the gas capture systems 160 and various sensors 148 to provide monitoring and control of the gas capture of undesirable gases (e.g., CO₂). For example, the sensors 148 may include gas composition sensors configured to provide concentration levels of the undesirable gases (e.g., CO₂) and other gases (e.g., oxygen, hydrogen) upstream, within, and/or downstream from each of the gas capture systems 160. The sensors 148 also may include temperature, pressure, and flow rate sensors configured to provide associated feedback regarding the flows of gas (e.g., air, exhaust gas) being treated by the gas capture systems 160, and flows of steam or other fluids being used in support of the gas capture systems 160. The control system 144 may use the sensor feedback to adjust operation of the gas capture systems 160, such as by adjusting characteristics of steam or other fluids (e.g., temperature, pressure, flow rate, and/or flow paths) in the gas capture systems 160, adjusting residence times in the gas capture systems 160, activating or deactivating one or more of the gas capture systems 160, adjusting the dryers (e.g., 200, 210, and 218), adjusting the fans 202, adjusting the valves 204, adjusting the HRSG 14 and/or extraction of the heated fluid 168 (e.g., content and conditions of steam and/or water, extraction points, etc.), adjusting electric heaters proving heat to the gas capture systems, adjusting the gas turbine system 12 (e.g., adjusting fuel/air ratio, combustion characteristics, fuel type, fuel additives, etc.), or any combination thereof, depending on concentration levels of the undesirable gases and operating modes (e.g., power production mode or power consumption mode). By adjusting various aspects of the gas treatment system 18 (e.g., multiple stages of gas capture systems 160) In coordination with the gas turbine system 12 and the HRSG 14, the combined cycle power plant 10 may be configured to provide a desired carbon footprint (e.g., a low carbon, a net neutral, or a net negative carbon footprint).

The gas capture systems 160 (e.g., 162, 164, and 166) may be configured in a variety of ways depending on the particular demands and CO₂ concentration levels of the combined cycle power plant 10 and the operating mode (e.g., power production mode or power consumption mode). Table 1 presents various scenarios for the gas capture systems 162, 164, and 166 in the combined cycle power plant 10. The following scenarios indicate each of the gas capture systems 162, 164, and 166 as either n/a (e.g., not present or active), sorbent-based such as described below with reference to FIG. 2, or solvent-based such as described below with reference to FIG. 3. The sorbent-based and solvent-based gas capture systems each may use the heated fluid 168 (e.g., steam and/or heated water) from the HRSG 14 and/or waste heat from the waste heat recover system 172 (e.g., 182, 184, and/or 186) as heat sources for the gas capture processes. Additionally, for each of the following scenarios, the sorbent-based systems may be the same or different in type, configuration, capacity, residence time, and/or any other characteristics. Similarly, for each of the following scenarios, the solvent-based systems may be the same or different in type, configuration, capacity, residence time, and/or any other characteristics. Finally, for each of the following scenarios, each of the gas capture systems 162, 164, and 166 may include one or more stages and/or parallel flows of gas capture.

TABLE 1
Gas Capture System Scenarios

| | Gas Capture System | Gas Capture System | Gas Capture System |
|---|---|---|---|
| Scenario | 162 (Air Intake) | 164 (Exhaust) | 166 (Exhaust) |
| 1 | Sorbent-Based | Sorbent-Based | Sorbent-Based |
| 2 | Solvent-Based | Sorbent-Based | Sorbent-Based |
| 3 | Solvent-Based | Solvent-Based | Sorbent-Based |
| 4 | Solvent-Based | Sorbent-Based | Solvent-Based |
| 5 | Solvent-Based | Solvent-Based | Solvent-Based |
| 6 | Sorbent-Based | Solvent-Based | Sorbent-Based |
| 7 | Sorbent-Based | Sorbent-Based | Solvent-Based |
| 8 | Sorbent-Based | Solvent-Based | Solvent-Based |
| 9 | n/a | Sorbent-Based | Sorbent-Based |
| 10 | n/a | Solvent-Based | Sorbent-Based |
| 11 | n/a | Sorbent-Based | Solvent-Based |
| 12 | n/a | Solvent-Based | Solvent-Based |
| 13 | Sorbent-Based | n/a | Sorbent-Based |
| 14 | Solvent-Based | n/a | Sorbent-Based |
| 15 | Sorbent-Based | n/a | Solvent-Based |
| 16 | Solvent -Based | n/a | Solvent-Based |
| 17 | Sorbent-Based | Sorbent-Based | n/a |
| 18 | Solvent-Based | Sorbent-Based | n/a |
| 19 | Sorbent-Based | Solvent-Based | n/a |
| 20 | Solvent-Based | Solvent-Based | n/a |
| 21 | Cryogenic | Cryogenic | Cryogenic |
| 22 | Sorbent-Based | Cryogenic | Cryogenic |
| 23 | Solvent-Based | Cryogenic | Cryogenic |
| 24 | n/a | Cryogenic | Cryogenic |
| 25 | Cryogenic | Sorbent-Based | Cryogenic |
| 26 | Cryogenic | Solvent-Based | Cryogenic |
| 27 | Cryogenic | n/a | Cryogenic |
| 28 | Cryogenic | Cryogenic | Sorbent-Based |
| 29 | Cryogenic | Cryogenic | Solvent-Based |
| 30 | Cryogenic | Cryogenic | n/a |
| 31 | Sorbent-Based | Sorbent-Based | Cryogenic |
| 32 | Solvent-Based | Solvent-Based | Cryogenic |
| 33 | Solvent-Based | Sorbent-Based | Cryogenic |
| 34 | Sorbent-Based | Solvent-Based | Cryogenic |
| 35 | n/a | Sorbent-Based | Cryogenic |
| 36 | n/a | Solvent-Based | Cryogenic |
| 37 | Sorbent-Based | n/a | Cryogenic |
| 38 | Solvent-Based | n/a | Cryogenic |
| 39 | n/a | n/a | Cryogenic |
| 40 | | | |
| 41 | Sorbent-Based | Cryogenic | Sorbent-Based |
| 42 | Solvent-Based | Cryogenic | Solvent-Based |
| 43 | Solvent-Based | Cryogenic | Sorbent-Based |
| 44 | Sorbent-Based | Cryogenic | Solvent-Based |
| 45 | n/a | Cryogenic | Sorbent-Based |
| 46 | n/a | Cryogenic | Solvent-Based |
| 47 | Sorbent-Based | Cryogenic | n/a |
| 48 | Solvent-Based | Cryogenic | n/a |
| 49 | n/a | Cryogenic | n/a |
| 50 | Cryogenic | Sorbent-Based | Sorbent-Based |
| 51 | Cryogenic | Solvent-Based | Solvent-Based |
| 52 | Cryogenic | Solvent-Based | Sorbent-Based |
| 53 | Cryogenic | Sorbent-Based | Solvent-Based |
| 54 | Cryogenic | n/a | Sorbent-Based |
| 55 | Cryogenic | n/a | Solvent-Based |
| 56 | Cryogenic | Sorbent-Based | n/a |
| 57 | Cryogenic | Solvent-Based | n/a |
| 58 | Cryogenic | n/a | n/a |

As indicated above, the disclosed embodiments include at least 58 scenarios for the gas capture systems 162, 164, and 166. Additional scenarios are also contemplated using other gas capture technologies and/or variations in the sorbent-based, solvent-based, and cryogenic gas capture systems. With the foregoing in mind, FIGS. 2 and 3 present embodiments of the sorbent-based and solvent-based gas capture systems.

In certain embodiments, the control system 144 and the monitoring system 146 may be used to monitor and control operation of the combined cycle power plant 10 in a plurality of operating modes (e.g., power production mode and power consumption mode), which may depend on energy demand, energy pricing, energy credits, gas capture credits, or any combination thereof. For example, at certain times, the energy demand and/or the energy pricing may decrease to a point at which it is not desirable to operate the combined cycle power plant 10 for power production. For example, the energy pricing may drop below a pricing threshold, such as a low pricing, a zero pricing, or a negative pricing for power production. The negative pricing may result in the energy credits (e.g., monetary rewards) to stop supplying power to the power grid. The gas capture credits may correspond to tax credits for capturing the undesirable gases, such as carbon capture credits (e.g., CO₂ capture credits). The gas capture credits (e.g., tax credits) may be higher when the gas turbine system 10 is non-firing or non-combusting (e.g., no fuel being combusted to generate combustion gas), such that gas capture (e.g., direct air capture) is occurring only for airflows without any exhaust gas flow 68. In contrast, the gas capture credits may be lower when the gas turbine system 10 is firing or combusting (e.g., fuel is being combusted to generate the combustion gas), such that the gas capture is occurring for the exhaust gas flow 68 (e.g., alone or in combination with gas capture for an airflow). Accordingly, the monitoring system 146 may be configured to monitor for current energy demand, current energy pricing, energy credits, gas capture credits, or other factors that may trigger a change in operation of the combined cycle power plant 10.

Accordingly, depending on the energy demand, energy pricing, energy credits, and gas capture credits, the control system 144 may change operation of the combined cycle power plant 10 to selectively operate in the power production mode or the power consumption mode. For example, the power production mode may include a firing mode or combustion mode of the gas turbine system 12, wherein the fuel supply 46 supplies fuel to the combustors 40 and fires a fuel air mixture to generate hot combustion gases, which then drive the turbine section 26 to generate electricity via the motor-generator 28 operating in a generator mode. In other words, the power production mode (e.g., firing mode) of the gas turbine system 12 actively combusts fuel with air to operate the gas turbine system 12 to generate electricity. In the power production mode, the exhaust gas flow 68 also passes through the HRSG 14, which in turn generates steam to operate the steam turbine system 16 to generate electricity via the load 116 (e.g., electric generator). The exhaust gas flow 68 then flows through the gas capture systems 164 and 166 to treat the exhaust gas flow 68 and obtain the captured gas 194 as discussed above.

However, if the monitoring system 146 determines that the energy demand and/or the energy pricing drops below a lower threshold and/or the energy credits and gas capture credits are above a threshold, then the control system 144 may control the combined cycle power plant 10 to switch from the power production mode to the power consumption mode. In the power consumption mode, which also may be described as a non-firing mode or non-combustion mode, the control system 144 controls the gas turbine system 12 to stop firing or combusting a fuel air mixture in the combustors 40, thereby stopping a flow of hot combustion gases through the turbine section 26. In other words, in the power consumption mode, the gas turbine system 12 may stop a supply of fuel from the fuel supply 46 to the combustors 40, stop igniting a fuel and air mixture, and thus stop generating the hot combustion gases that would otherwise drive the turbine section 26. As a result, the power consumption mode no longer drives the gas turbine system 12 via expansion of the hot combustion gases through the turbine section 26. Instead, in the power consumption mode, the control system 144 is configured to operate the motor-generator 28 in a motor mode (e.g., electric motor), which enables the motor-generator 28 (e.g., electric motor) to drive rotation of the gas turbine system 12. As the motor-generator 28 (e.g., electric motor) rotates the gas turbine system 12, the compressor section 22 rotates and compresses the air intake flow 60 from the air intake section 20, such that the compressed air 62 flows internally through the combustor section 24 and the turbine section 26. Accordingly, the power consumption mode of the gas turbine system 12 consumes electricity to drive rotation of the gas turbine system 12 using the motor-generator 28 (e.g., electric motor), and flows air internally through the compressor section 22, the combustor section 24, and the turbine section 26.

The airflow from the gas turbine system 12 may then be routed directly or indirectly to one or both of the gas capture systems 164 and 166. For example, the control system 144 may be configured to control various valves and flow controls to extract the airflow exiting from the turbine section 26, such that the airflow may bypass the HRSG 14 and/or the gas capture system 164. For example, the control system 144 may be configured to control one or more air circuits (e.g., bypass flow paths or circuits) to direct the airflow from the turbine section 26 to the gas capture system 166 (or one or both of the gas capture systems 164 and 166). In certain embodiments, as discussed in further detail below, the control system 144 also may be configured to control one or more air circuits (e.g., bleed lines or circuits) from the compressor section 22 to the gas capture system 166 (or one or both of the gas capture systems 164 and 166). Additionally, the control system 144 may be configured to operate one or more air movers, such as air compressors, fans, and/or blowers, to induce or force an airflow internally through the gas turbine system 12 and/or at least partially or entirely external to the gas turbine system 12 to the gas capture system 166 (or one or both of the gas capture systems 164 and 166).

The gas capture system 166 (or one or both of the gas capture systems 164 and 166) is then configured to treat the airflow to help treat the air in the environment. For example, the gas capture system 166 may reduce the undesirable gases (e.g., CO₂) in the environment to output the captured gas 194 and to output a treated air output through the exhaust stack 214. In certain embodiments, the gas capture system 166 may be used to treat the airflow without the gas capture systems 162 and 164. In some embodiments, the gas capture system 166 may be used in combination with the gas capture system 162 and/or the gas capture system 164 to treat the airflow for air treatment and capturing of the undesirable gases (e.g., CO₂) to obtain the captured gas 194.

In the power consumption mode, the gas capture systems 162, 164, and/or 166 may use heat from one or more heat sources to help with the gas capture process. However, in the power consumption mode, the HRSG 14 may not produce any steam for operation of the steam turbine system 16, because the gas turbine system 12 does not fire to produce combustion gases, and thus the HRSG 14 does not transfer heat from the exhaust gas flow 68 to water to generate the steam. Accordingly, the control system 144 may stop operation of the HRSG 14 and the steam turbine system 16 during the power consumption mode. In some embodiments, due to low, zero, or negative energy pricing, the control system 144 may be configured to operate the HRSG 14 using heat provided by electric heaters, such that steam can be used as a heat source for the gas capture systems 162, 164, and/or 166. However, in other embodiments, the HRSG 14 and the steam turbine system 16 may not operate during the power consumption mode, and one or more different heat sources (e.g., electric heaters) may be used to provide heat to the gas capture systems 162, 164, and/or 166. For example, the electric heaters may be used to directly or indirectly heat a solvent in a solvent-based gas capture system, a sorbent material in a sorbent-based gas capture system, or a combination thereof.

Additionally, in certain embodiments, one or more additional combustion systems, such as an additional gas turbine system, a reciprocating engine system, a furnace, or other combustion system, may be configured to provide hot combustion gases to the HRSG 14 for steam production to operate the steam turbine system 16 and/or to provide exhaust gas into the gas capture systems 164 and 166. For example, if another combustion system continues to operate in a power production mode while the gas turbine system 12 operates in a power consumption mode, the exhaust gas from the other combustion system can still be used to operate the HRSG 14 and the steam turbine system 16 of the combined cycle power plant 10 and/or to continue exhaust gas treatment through the gas capture systems 164 and 166, along with the airflow being provided to one or more of the gas capture systems 162, 164, and/or 166.

In certain embodiments, the control system 144 and the monitoring system 146 may be used to monitor and control operation of the combined cycle power plant 10 in a plurality of load-based operating modes (e.g., full load mode and part load mode) associated with the power production mode, wherein the part load mode may be less than or equal to about 30, 40, 50, 60, 70, 80, or 90 percent of a full load operating state of the combined cycle power plant 10. In the part load mode, the control system 144 may be configured to route one or more airflows through the gas capture systems 162, 164, and/or 166 in addition to exhaust gas flowing through the gas capture systems 164 and 166. For example, during the part load mode, the gas turbine system 12 may produce a substantially lesser flow or quantity of exhaust gas for treatment by the gas capture systems 164 and 166, resulting in some level of unused capacity for gas treatment in the gas capture systems 164 and 166. As an example, the part load mode may result in use of only 30, 40, 50, 70, 70, 80, or 90 percent of the capacity of the gas capture systems 164 and 166. The unused capacity may be based on the flow rate of the exhaust gas, the percentage of undesirable gases in the exhaust gas, the rated capacity of the gas capture systems 164 and 166, or various other factors. The control system 144 may selectively enable airflows to one or both of the gas capture systems 164 and 166 during the part load mode, thereby removing or capturing the undesirable gases (e.g., CO₂) from both the exhaust gas and the environmental air. Additionally, gas capture systems 164 and 166 can use the excess heat available from the exhaust gas and/or steam from the HRSG 14 to help desorb the undesirable gases from sorbent materials, strip the undesirable gases from solvents, or any combination thereof, depending on the configuration of the gas capture systems 164 and 166. The part load mode may be used with the power production mode in any of the embodiments discussed in detail below.

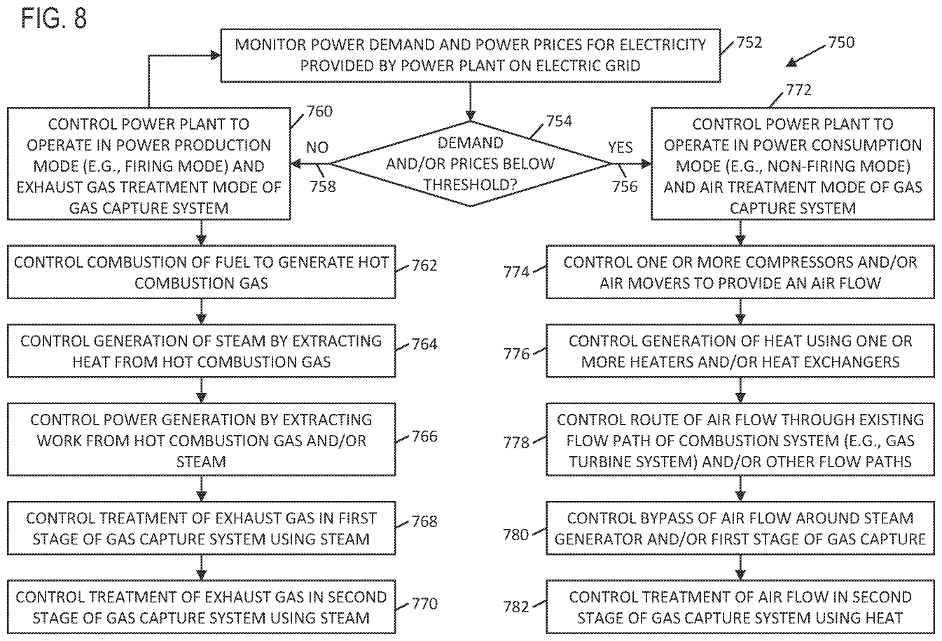

Although the gas capture systems 162, 164, and 166 may include a variety of configurations and gas capture processes, FIGS. 2 and 3 depict possible implementations that may be used for one or more of the gas capture systems 162, 164, and 166. Additionally, FIGS. 4-7 illustrate possible implementations of the gas treatment system 18 to treat exhaust gas and air in different modes, such as the power production mode and the power consumption mode. FIG. 8 illustrates a process of operating the gas treatment system 18 in accordance with the embodiments presented in FIGS. 1-7.

FIG. 2 is a schematic of an embodiment of a gas capture system 160 of the multi-stage gas treatment system 18 of FIG. 1, illustrating a sorbent-based gas capture system 250. In the illustrated embodiment, the sorbent-based gas capture system 250 includes a sorbent-based gas capture assembly or unit 252 (e.g., adsorbers or adsorption units) having a plurality of sorbent-containing conduits 254, such as sorbent-containing conduits 256 and 258. The sorbent-containing conduits 254 (e.g., 256 and 258) may be sorbent-lined along interior surfaces, sorbent-packed within interior volumes, or generally filled with at least 10, 20, 30, 40, 50, 60, 70, 80, 90, or more percent by volume of sorbent material. However, the sorbent-based gas capture unit 252 may include any number of sorbent-containing conduits 254, such as 2, 3, 4, 5, 6, 7, 8, 9, 10, or more, which are configured in parallel and/or series. Each of the sorbent-containing conduits 254 (e.g., 256 and 258) includes an outer conduit wall 260 disposed circumferentially about a flow path 262 along a central axis 264 from an inlet 266 to an outlet 268, wherein a sorbent material 270 is disposed along and/or within a central bore or interior surface 272 of the outer conduit wall 260.

The sorbent material 270 (e.g., solid adsorbents) may cover, coat, or generally line at least 50, 60, 70, 80, 90, 95, or 100 percent of the interior surface 272 of the outer conduit wall 260. Additionally or alternatively, the sorbent material 270 may at least partially fill or pack an interior volume of the central bore or interior surface 272, such that voids remain to facilitate fluid flow (e.g., a void fraction of less than or equal to 10, 20, 30, 40, or 50 percent). For example, the sorbent material 270 may include a plurality of particles, beads, strips, strands, mesh, or other distributed structures, which leave voids for fluid flow. In certain embodiments, the sorbent material 270 may be coupled to one or more interior structures within the sorbent-containing conduits 254, such as, for example, one or more of a wire grid or mesh, radial projections, baffles, fins, honeycomb structures, or any combination thereof. Furthermore, in some embodiments, the central axis 264 extending from the inlet 266 to the outlet 268 may define flow path 262 as a linear flow path, a curved flow path, a winding or serpentine flow path, a spiral or helical flow path, a tortuous flow path, an expanding and contracting flow path, a flow path with splits and/or unions, or any combination thereof. For example, the flow path 262 may be defined as a tortuous flow path and include any number or configuration of the foregoing flow paths. The sorbent material 270 may include one or more sorbent materials configured to adsorb the undesirable gases, such as sorbent materials designed or suitable for adsorption of carbon oxides (CO_{X}) such as carbon dioxide (CO₂) and carbon monoxide (CO), nitrogen oxides (NO_{X}), sulfur oxides (SO_{X}) such as sulfur dioxide (SO₂), methane (CH₄), or any other undesirable gases as described herein or subject to regulations and/or considered greenhouse gases. For example, the sorbent materials 270 may include porous, solid-phase materials, including mesoporous silicas, zeolites (e.g., aluminosilicates), and metal-organic frameworks (MOFs) and covalent organic frameworks (COFs). The foregoing sorbent materials 270 may be particularly well-suited for CO₂ adsorption in the sorbent-based gas capture unit 252. However, any suitable sorbent materials 270 may be used depending on the desired target for gas capture of undesirable gases. In certain embodiments, a plurality of the sorbent-based gas capture systems 250 may be used in series, wherein each of the sorbent-based gas capture system 250 uses the same or different sorbent materials 270 to remove and capture the same or different undesirable gases in stages.

The sorbent-based gas capture system 250 may be configured to alternate the various sorbent-based gas capture unit 252 between an adsorption mode (e.g., adsorbing the undesirable gases into the sorbent material 270) and a desorption mode (e.g., desorbing the undesirable gases from the sorbent material 270) using the controller 150 of the control system 144 and the sensors 148 of the monitoring system 146. For example, using the controller 150, the sorbent-based gas capture system 250 may operate the sorbent-based gas capture unit 256 in the adsorption mode while operating the sorbent-based gas capture unit 258 in the desorption mode, and vice versa. The sorbent-based gas capture system 250 also may be configured to operate multiple units (e.g., 2, 3, 4, or more) of the sorbent-based gas capture units 252 in the adsorption mode while operating multiple units (e.g., 2, 3, 4, or more) of the sorbent-based gas capture units 252 in the desorption mode, wherein the multiple units may be arranged in series, in parallel, or a combination thereof. The controller 150 is configured to alternate the sorbent-based gas capture units 252 between the adsorption and desorption modes via a plurality of upstream and downstream systems, such as an upstream flow distribution system 274 and a downstream flow distribution system 276. The upstream flow distribution system 274 includes a heated fluid supply system 278 (e.g., steam and/or heated water supply system) and a gas supply system 280, while the downstream flow distribution system 276 includes a post-desorption processing system 282 (e.g., gas, steam, and/or heated water processing system) and a treated gas processing system 284. The heated fluid supply system 278 may rely on the steam 168 generated using waste heat and/or heat from combustion in the gas turbine system 12 during the power production mode of the combined cycle power plant 10, whereas the heated fluid supply system 278 may rely on the steam 168 generated using electric heaters, waste heat, and/or other available heat sources during the power consumption mode of the combined cycle power plant 10. In some embodiments, the steam 168 may be replaced or supplemented with other heated fluids, direct or indirect heating via electric heaters, or other heating arrangements, particularly if needed for the power consumption mode.

For the desorption mode, the sorbent-based gas capture unit 252 may be configured to route the heated fluid 168 in direct contact with the sorbent material 270 through the sorbent-containing conduits 254 (e.g., direct heat transfer), through or around the sorbent-containing conduits 254 via one or more heat exchange conduits without contacting the sorbent material 270 (e.g., indirect heat transfer), or a combination thereof. Again, one or more additional heat sources (e.g., electric heaters) may be used to provide heat to the sorbent material 270. In certain embodiments of the desorption mode as discussed below, the sorbent-based gas capture unit 252 may route the heated fluid 168 directly through the sorbent material 270 in the sorbent-containing conduits 254 to desorb the undesirable gases (e.g., CO₂) into the heated fluid 168 to produce a gas/heated fluid flow for further processing, or the sorbent-based gas capture unit 252 may use the heated fluid 168 for indirect heat transfer to the sorbent material 270 for desorption of the undesirable gases while using another flow-inducing system (e.g., a vacuum system) to direct the undesirable gases downstream for further processing. For example, the vacuum system may include one or more fans, blowers, or pumps to draw a flow and/or create a vacuum to induce a flow out of the sorbent-containing conduits 254 into the downstream processing components. Furthermore, in some embodiments, the heated fluid 168 may use steam, waste heat, and/or electric heaters to heat water to produce a heated water, which is then routed through the sorbent-based gas capture unit 252 for direct contact with the sorbent material 270 and desorption of the undesirable gases from the sorbent material 270. Accordingly, the disclosed embodiments may use a variety of heated fluids 168 (e.g., steam, heated water, fluid heated by steam, or a combination thereof) as a heat source, which may apply heat directly or indirectly to the sorbent materials 270 to facilitate the desorption process.

In certain embodiments, a continuous process, where a wheel of sorbent material 270 is rotated from adsorption, desorption and cooling, can be performed to provide a continuous stream of captured undesirable gases. For example, the wheel of sorbent material 270 may extend into each of the plurality of conduits 254, and continuously rotate through the conduits 254. During the wheel rotation, one or more of the conduits 254 flow the gas 286 being treated to remove the undesirable gases, while one or more of the conduits 254 simultaneously flow the heated fluid 168 (e.g., steam and/or heated water) to remove and capture the undesirable gas (e.g., CO₂) to generate the captured gas 194. For the desorption, the heated fluid 168 (e.g., steam and/or heated water) may be routed or generally configured to provide direct heat transfer and/or indirect heat transfer to the sorbent material 270, thereby helping to separate and capture the undesirable gas.

In the illustrated embodiment, the upstream flow distribution system 274 is configured to distribute flows and alternate flows (e.g., when changing between the adsorption and desorption modes) of the heated fluid 168 (e.g., steam and/or heated water) and a gas 286 (e.g., intake airflow 60 and/or exhaust gas flow 68) to the plurality of sorbent-containing conduits 254 (e.g., 256 and 258) of the sorbent-based gas capture unit 252. The heated fluid supply system 278 includes one or more steam supplies, heated water supplies, waste heat supplies, and/or electric heaters. For example, the heated fluid supply system 278 may include the HRSG 14 and the waste heat recovery system 172 (e.g., 182, 184, and/or 186), which may be configured to generate the heated fluid 168 (e.g., steam and/or heated water). The heated fluid supply system 278 also includes a heated fluid control 288 (e.g., steam and/or heated fluid control) having one or more heated fluid control components 290, 292, and 294, which may be configured to process, adjust, and/or control characteristics of the heated fluid 168 upstream from the sorbent-containing conduits 254 (e.g., 256 and 258) of the sorbent-based gas capture unit 252. For example, the heated fluid control component 290 may include a thermal control component (e.g., steam/hot water temperature control component), such as a heat exchanger, an electric heater, a cooler, or any combination thereof, configured to adjust (e.g., increase or decrease) a temperature of the heated fluid 168. The heat exchanger may exchange heat with water, lubricant, coolant, refrigerant, or some other thermal fluid. In some embodiments, the waste heat recovery system 172 may be used for heat transfer in the heater exchanger. The heated fluid control component 292 may include a pressure control component, such as a pressure regulator, an expander or expansion chamber, a constrictor or constriction chamber, a fan or pump to add energy, a turbine to extract energy, or another suitable pressure controller. The heated fluid control component 294 may include a pre-treatment component, such as a particulate filter, a cold water drain, and/or other pre-treatment components configured to alter characteristics of the heated fluid 168 (e.g., steam and/or heated water) or remove contaminants. The heated fluid supply system 278 also may include one or more valves 296 configured to control the distribution of the heated fluid 168 (e.g., steam and/or heated water) to the plurality of sorbent-containing conduits 254 (e.g., 256 and 258) of the sorbent-based gas capture unit 252, as indicated by distribution conduits or lines 298 and 300. For example, the valves 296 may include one or more 2-way valves, 3-way valves, or distribution manifolds to distribute the heated fluid 168 (e.g., steam and/or heated water) in response to control signals from the controller 150.

For the distribution of the gas 286, the gas supply system 280 of the upstream flow distribution system 274 includes a gas pre-treatment 302 having one or more gas pre-treatment components 304, 306, and 308, which may be configured to process, adjust, and/or control characteristics of the gas 286 (e.g., intake airflow 60 or exhaust gas flow 68) upstream from the sorbent-containing conduits 254 (e.g., 256 and 258) of the sorbent-based gas capture unit 252. For example, the gas pre-treatment component 304 may include a thermal control component (e.g., gas temperature control component), such as a heat exchanger, an electric heater, a cooler, or any combination thereof, configured to adjust (e.g., increase or decrease) a temperature of the gas 286. The heat exchanger may exchange heat with water, exhaust gas, compressor bleed flow, waste heat, or some other thermal fluid. In some embodiments, the waste heat recovery system 172 may be used for heat transfer in the heater exchanger. The gas pre-treatment component 306 may include a pressure control component, such as a pressure regulator, an expander or expansion chamber, a constrictor or constriction chamber, a fan or pump to add energy, a turbine to extract energy, or another suitable pressure controller. The gas pre-treatment component 308 may include one or more contaminant removal units, such as a particulate filter, a moisture removal unit or dryer, a chemical removal unit, and/or other removal units configured clean the gas 286. The gas supply system 280 also may include one or more valves 310 configured to control the distribution of the gas 286 to the plurality of sorbent-containing conduits 254 (e.g., 256 and 258) of the sorbent-based gas capture unit 252, as indicated by distribution conduits or lines 312 and 314. For example, the valves 310 may include one or more 2-way valves, 3-way valves, or distribution manifolds, perforated plates and/or flow distribution packing to distribute the gas 286 in response to control signals from the controller 150.

The downstream flow distribution system 276 is configured to distribute flows and alternative flows (e.g., when changing between the adsorption and desorption modes) from the plurality of sorbent-containing conduits 254 (e.g., 256 and 258) of the sorbent-based gas capture unit 252 to the post-desorption processing system 282 and the treated gas processing system 284. The post-desorption processing system 282 may include one or more valves 316 configured to control the distribution of a captured gas/heated fluid flow (e.g., gas, steam, and/or heated water) from the plurality of sorbent-containing conduits 254 (e.g., 256 and 258) of the sorbent-based gas capture unit 252, as indicated by distribution conduits or lines 318 and 320. For example, the valves 316 may include one or more 2-way valves, 3-way valves, or manifolds to collect the captured gas/heated fluid flow in response to control signals from the controller 150. In certain embodiments, the captured gas/heated fluid flow is a result of the desorption mode, wherein the heated fluid 168 (e.g., steam and/or heated water) is directed through the sorbent-containing conduit 254 to desorb the undesirable gases (e.g., CO₂) from the sorbent material 270 in the respective sorbent-containing conduit 254. Accordingly, the post-desorption processing system 282 also may include a post-desorption processor 322 having one or more post-desorption processing components 324, 326, and 328 (e.g., gas, steam, and/or heated water processing components), which may be configured to process, adjust, and/or control characteristics of the captured gas/heated fluid flow (e.g., gas, steam, and/or heated water flow) from the sorbent-containing conduits 254 (e.g., 256 and 258) of the sorbent-based gas capture unit 252. For example, the post-desorption processing component 324 may include a captured gas/heated fluid separator configured to separate the heated fluid 168 (e.g., steam and/or heated water) from the captured gas, thereby outputting a water 330 (e.g., condensate) and the captured gas 194. Examples of the captured gas/heated fluid separator include thermal control components, pressure control components, chemical separation components, or a combination thereof. For example, the captured gas/heated fluid separator may be configured to condense or cool the heated fluid 168 using a condenser. The post-desorption processing component 326 may include one or more removal units configured to remove contaminants from the water 330 and/or the captured gas 194. For the water 330, the removal units may include particulate filters and/or water treatment units. For the captured gas 194, the removal units may include particulate filters, water removal units or dryers, or further gas treatment units. The post-desorption processing component 328 may include one or more pressure control components and/or flow control components, such as one or more pumps for the water 330 and one or more compressors for the captured gas 194. The post-desorption processing components 328 also may include one or more vacuum pumps configured to suction the captured gas/heated fluid flow from the sorbent-based gas capture unit 252.

For the distribution of the gas 286, the treated gas processing system 284 of the downstream flow distribution system 276 may include one or more valves 332 configured to control the distribution of treated gas flow from the plurality of sorbent-containing conduits 254 (e.g., 256 and 258) of the sorbent-based gas capture unit 252, as indicated by distribution conduits or lines 334 and 336. For example, the valves 332 may include one or more 2-way valves, 3-way valves, or manifolds to collect the treated gas flow in response to control signals from the controller 150, thereby outputting a treated gas 338. The treated gas is a result of the adsorption mode, wherein the gas 286 (e.g., intake airflow 60 or exhaust gas flow 68) is directed through the sorbent-containing conduit 254 to adsorb the undesirable gases (e.g., CO₂) into the sorbent material 270 in the respective sorbent-containing conduit 254, thereby reducing the content or concentration levels of the undesirable gases in the remaining treated gas flow.

The control system 144 (e.g., controller 150) is configured to receive feedback from the sensors 148 to facilitate adjustments of various operating parameters of the sorbent-based gas capture unit 252. For example, the control system 144 may be configured to selectively operate one or more heat sources to provide the heat for desorption depending on the operating mode of the combined cycle power plant 10, such as the power production mode and the power consumption mode. In certain embodiments, the control system 144 may selectively provide steam and/or heated water from the HRSG 14 during the power production mode, whereas the control system 144 may selectively provide heat using one or more electric heaters during the power consumption mode.

By further example, the control system 144 may be configured to alternate flows (e.g., heat fluid 168 and gas 286) through the plurality of sorbent-containing conduits 254 (e.g., 256 and 258), such that the sorbent-containing conduits 254 can alternate between adsorption and desorption modes. In the adsorption mode, the sorbent-containing conduit 254 (e.g., 256 or 258) receives a flow of the gas 286, adsorbs the undesirable gases (e.g., CO₂) from the gas 286 into the sorbent material 270, and outputs gas 286 with a reduced content or concentration level of the undesirable gases as the treated gas 338. The adsorption mode is an exothermic process, which generates heat that is carried away along with the treated gas 338. In the desorption mode, the sorbent-containing conduit 254 (e.g., 256 or 258) receives a flow of the heated fluid 168 (e.g., steam and/or heated water), desorbs the undesirable gases (e.g., CO₂) from the sorbent material 270 into the heated fluid 168, and outputs the heated fluid 168 with the desorbed undesirable gases (e.g., rich in the undesirable gases such as CO₂) as the captured gas/heated fluid flow. The desorption mode is an endothermic process, and the heated fluid 168 provides sufficient heat (e.g., directly or indirectly) to drive the desorption of the undesirable gases (e.g., CO₂) from the sorbent material 270.

The control system 144 is configured to monitor the sensors 148, such as sensors 148 at or upstream from the inlets 266 and sensors 148 at or downstream from the outlets 268, to evaluate rates of adsorption and desorption, concentration levels of the undesirable gases, and other characteristics impacting the adsorption and desorption modes in the respective sorbent-containing conduits 254 (e.g., 256 and 258). If the sensors 148 indicate a need to alternate modes (e.g., adsorption and desorption modes) of the sorbent-containing conduits 254 (e.g., 256 and 258), then the control system 144 may be configured to control the valves 296, 310, 316, and 332 to change from a flow of heated fluid 168 to gas 286 in one of the sorbent-containing conduits 254 and to change from a flow of gas 286 to heated fluid 168 in another one of the sorbent-containing conduits 254. For the heated fluid 168 (e.g., steam and/or heated water) used in one of the sorbent-containing conduits 254, the control system 144 may be configured to control the HRSG 14, the waste heat recovery system 172, the heated fluid control 288, one or more electric heaters, or any combination thereof, to control characteristics of the heated fluid 168 (e.g., temperature, pressure, flow rate, steam content, water content, etc.). For the gas 286 used in one of the sorbent-containing conduits 254, the control system 144 may be configured to control the gas pre-treatment 302 to control characteristics of the gas 286 (e.g., temperature, pressure, flow rate, etc.). Similarly, the control system 144 is configured to control the post-desorption processor 322 to control the processing of captured gas/heated fluid discharged from one or more of the sorbent-containing conduits 254.

For the multi-stage gas treatment system 18, the control system 144 also coordinates control between the plurality of gas capture system 160 based on the operating modes of the combined cycle power plant 10, thereby providing a desired reduction in concentration levels of the undesirable gas (e.g., CO₂) to achieve a desired carbon footprint (e.g., a low carbon, a net neutral, or a net negative carbon footprint). In addition, after desorption is completed and prior to adsorption, a stream of cold water or other coolant can be applied through sorbent-based gas capture unit 252 to cool down the sorbent-containing conduits 254 to the desired temperatures prior to the next adsorption step.

FIG. 3 is a schematic of an embodiment of a gas capture system 160 of the multi-stage gas treatment system 18 of FIG. 1, illustrating a solvent-based gas capture system 350. The solvent-based gas capture system 350 includes an absorber 352, a solvent supply system 354, and a solvent discharge system 356. The solvent-based gas capture system 350 may use one or more solvents for capturing the undesirable gases. Example solvents include monoethanolamine (MEA), diglycolamine (DGA), advanced amine solvents, amino acid salts, carbonate solvents, aqueous ammonia, immiscible liquids, and ionic liquids. As discussed below, the solvent-based gas capture system 350 uses the heated fluid 168 (e.g., from the HRSG 14), waste heat (e.g., from the waste heat recovery system 172), and/or other heat sources (e.g., electric heaters) to facilitate the gas capture of undesirable gases.

As discussed in further detail below, the solvent supply system 354 is configured to supply a gas lean solvent 358 into the absorber 352 through a conduit 360 coupled to a solvent distributor 362 having a plurality of nozzles 364. The nozzles 364 are configured to output a solvent dispersion 366 into an interior volume 368 of the absorber 352. The solvent dispersion 366 helps to distribute the gas lean solvent 358 more uniformly throughout the interior volume 368, such that the solvent has a more uniform temperature distribution when flowing downwardly through the absorber 352 toward the solvent discharge system 356. The conduit 360 is coupled to a solvent inlet 370 of the absorber 352, while the solvent discharge system 356 is coupled to a solvent outlet 372 of the absorber 352.

The solvent discharge system 356 is configured to receive a gas rich solvent 374 from the solvent outlet 372 and route the gas rich solvent 374 to a solvent regeneration system 376. The solvent discharge system 356 also includes a gas compressor 378 downstream from the solvent regeneration system 376, a gas dryer 380 downstream from the gas compressor 378, and an outlet of a captured gas 194 downstream from the gas dryer 380. The solvent discharge system 356 also provides a return conduit 382 from the solvent regeneration system 376 back to the solvent supply system 354, such that a regenerated solvent may be returned back to the solvent supply system 354 as a gas lean solvent 358.

The absorber 352 also includes a gas inlet 384 configured to receive a gas 286 (e.g., intake airflow 60 or exhaust gas flow 68) into the absorber 352, and a gas outlet 386 configured to discharge a treated gas 338 out of the absorber 352. In the illustrated embodiment, the absorber 352 includes a vessel or enclosure 388 having a top portion 390, a bottom portion 392, and an intermediate portion 394 disposed axially between the top and bottom portions 390 and 392 relative to a central axis 396 of the enclosure 388. In the following discussion, reference may be made to an axial direction or axis 398 disposed along the central axis 396, a radial direction or axis 400 crosswise or perpendicular to the central axis 396, and a circumferential direction or axis 402 extending circumferentially about the central axis 396. The top portion 390 includes a top plate or cover 404 having the gas outlet 386 coaxial with the central axis 396. However, the gas outlet 386 may be disposed offset from the central axis 396 or at other locations along the top portions 390.

The intermediate portion 394 includes a sidewall 406 extending in the circumferential direction 402 about the central axis 396. For example, the sidewall 406 may be an annular sidewall, a square shaped sidewall, a rectangular sidewall, or any other suitable shape that extends around the central axis 396. In certain embodiments, the gas outlet 386 may be disposed in the sidewall 406 along the top portion 390. Additionally, the solvent inlet 370 may be disposed along the top plate or cover 404 or the sidewall 406 in the top portion 390.

The bottom portion 392 may include a base plate 408 below the gas inlet 384 and the solvent outlet 372. In the illustrated embodiment, the gas inlet 384 and the solvent outlet 372 are disposed in the sidewall 406 along the bottom portion 392. However, in certain embodiments, the gas inlet 384 and/or the solvent outlet 372 may be disposed in the base plate 408 in the bottom portion 392. In some embodiments, the gas inlet 384 may include a plurality of gas inlets and/or the solvent outlet 372 may include a plurality of solvent outlets.

Within the interior volume 368 of the absorber 352, the absorber 352 may further include one or more sets of a packing 410, a support tray or screen 412, and a solvent distributor 414 having a plurality of nozzles 416. For example, in the illustrated embodiment, the absorber 352 includes four sets of components (e.g., the packing 410, the support tray or screen 412, and the solvent distributor 414) disposed between the solvent distributor 362 and the bottom portion 392 having the gas inlet 384 and the solvent outlet 372. The packing 410 may include a plurality of beads, balls, or mixture inducing structures, which are configured to facilitate mixing between the gas 286 and the gas lean solvent 358 being supplied into the interior volume 368 of the absorber 352. The support tray or screen 412 may include a wire mesh, a plate having a plurality of openings, or another suitable structure that holds the packing 410 in position while permitting fluid flow of gas and solvent through the support tray or screen 412 in opposite directions through the absorber 352. The solvent distributor 414 may be similar to the solvent distributor 362, and thus the nozzles 416 may be distributed in a uniform manner throughout the interior volume 368 to output a solvent dispersion 418 to better distribute the solvent passing through the packing 410 and the support tray or screen 412. The sets of the packing 410, the support tray or screen 412, and the solvent distributor 414 are spaced apart from one another along the central axis 396. However, the spacing may be increased or decreased or even eliminated in certain embodiments of the absorber 352.

In operation, the absorber 352 is configured to create a cross-flow or opposing flow of the gas lean solvent 358 and the gas 286 within the interior volume 368, thereby facilitating gas absorption of certain undesirable gases (e.g., CO₂) from the gas 286 into the gas lean solvent 358. As illustrated, at the bottom portion 392, the gas 286 enters the absorber 352 through the gas inlet 384, and the gas 286 flows upwardly through the interior volume 368 of the absorber 352 as indicated by arrows 420. The gas 286 entering the absorber 352 as indicated by arrows 420 may form bubbles of the gas 286 that rise upwardly through the gas lean solvent 358 within the interior volume 368. The gas 286 then passes through each subsequent stage or set of the packing 410, the support tray or screen 412, and the solvent distributor 414.

At the top portion 390, the solvent supply system 354 feeds the gas lean solvent 358 into the interior volume 368 through the solvent inlet 370, the conduit 360, the solvent distributor 362, and the plurality of nozzles 364. Again, the nozzles 364 may be distributed at various positions across the interior volume 368 to help distribute the gas lean solvent 358 more uniformly throughout the interior volume 368, as indicated by the solvent dispersions 366. The gas lean solvent 358 then flows downwardly through the interior volume 368 through each subsequent set or stage of the packing 410, the support tray or screen 412, and the solvent distributor 412 having the nozzles 416. As the gas lean solvent 358 passes through each packing 410, the various beads, balls, or mixing structures in the packing 410 are configured to help mix the gas lean solvent 358 with the gas 286, thereby helping to absorb various undesirable gases from the gas 286 into the gas lean solvent 358. For example, the gas lean solvent 358 may be configured to absorb carbon dioxide (CO₂) or other undesirable gases as discussed in detail above. As the absorption process occurs, heat is generated within the absorber 352, thereby raising the temperature of the solvent within the absorber 352. In certain embodiments, a thermal control system (e.g., heat exchanger, coolers, etc.) may be coupled to the absorber 352 to control the temperatures, and improve the efficiency of the absorption process. The absorption process continues within each set or stage of the packing 410, the support tray or screen 412, and the solvent distributor 414. Between each stage or set, the solvent distributor 414 helps to better distribute the solvent as indicated by the solvent dispersions 418. The solvent dispersions 418 may help to uniformly mix the solvent with the gas 286 and prove more uniformity in the temperature distribution. The absorption process then repeats in the next set or stage of the packing 410, the support tray or screen 412, and the solvent distributor 414.

Eventually, the absorber 352 discharges a gas rich solvent 374 at the bottom portion 392 through the solvent outlet 372, and the absorber 352 discharges the treated gas 338 at the top portion 390 through the gas outlet 386. The treated gas 338 may be substantially free or stripped of one or more undesirable gases (e.g., CO₂). In contrast, the gas rich solvent 374 may have absorbed the one or more undesirable gases (e.g., CO₂). Accordingly, the gas rich solvent 374 may be described as a CO₂ rich solvent (or other gas rich solvent depending on the undesirable gas), while the gas lean solvent 358 may be described as a CO₂ lean solvent (or other gas lean solvent depending on the undesirable gas) and the particular gas absorption occurring in the absorber 352. Similarly, the gas 352 may be described as a CO₂ containing or rich gas (or other containing or rich gas depending on the undesirable gas), while the treated gas 338 may be described as a CO₂ reduced, lean, or free gas (or other reduced, lean, or free gas depending on the undesirable gas) and the particular gas absorption occurring in the absorber 352. The gas absorption discussed herein is intended to cover any one or more of the undesirable gases described herein, or any other regulated or greenhouse gases.

The gas rich solvent 374 output from the absorber 352 flows into the solvent regeneration system 376, which may be configured to capture the undesirable gases (e.g., CO₂) in the gas rich solvent 374 and regenerate the solvent (e.g., remove the undesirable gases (e.g., CO₂) for reuse of the solvent as the gas lean solvent 358). In the illustrated embodiment, the solvent-based gas capture system 350 comprises a steam supply system 422 coupled to the solvent regeneration system 376 to facilitate solvent regeneration and capture of the captured gas 194. In particular, the steam supply system 422 includes one or more sources of the heated fluid 168 (e.g., steam and/or heated water), such as the HRSG 14, the waste heat recovery system 172 (e.g., 182, 184, and 186), and/or other heat sources (e.g., electric heaters). The steam supply system 422 may inject the heated fluid 168 (e.g., steam and/or heated water) directly into the solvent regeneration system 376 for the solvent regeneration and capture of the captured gas 194. In some embodiments, the steam supply system 422 may further process and/or control characteristics of the heated fluid 168 (e.g., steam and/or heated water) prior to injection into the solvent regeneration system 376, such as, for example, temperature control and/or pressure control. In some embodiments, the steam supply system 422 may use the heated fluid 168 (e.g., steam and/or heated water) and/or the waste heat from the waste heat recovery system 172 as an indirect heat source for the absorber 352 and/or to generate steam in a boiler. In each of these embodiments, the heated fluid 168 (e.g., steam and/or heated water) and the waste heat from the waste heat recovery system 172 may be acquired and/or processed as discussed in detail above with reference to FIGS. 1 and 2.

Accordingly, the undesirable gases (e.g., CO₂) may be output from the solvent regeneration system 376 to the gas compressor 378 as indicated by arrow 424, such that the gas compressor 378 is configured to compress the undesirable gases prior to being dried by the gas dryer 380. The gas dryer 380 then removes any moisture content in the compressed undesirable gases from the gas compressor 378, and then outputs the compressed and dried undesirable gases as the captured gas 194. Additionally, the solvent regeneration system 376 outputs the regenerated solvent as the gas lean solvent 358 being returned to the solvent supply system 354 through the return conduit 382. The regenerated solvent is essentially the gas rich solvent 374 with the undesirable gases removed in the solvent regeneration system 376.

In the solvent supply system 354, the gas lean solvent 358, whether an original supply of gas lean solvent 358 or a regenerated solvent from the solvent regeneration system 376, is supplied into the absorber 352 with one or more components 426, 428, 430, and 432. The components 426, 428, 430, and 432 may include one or more solvent pumps, solvent filters or treatment systems, one or more heat exchangers configured to cool the gas leans solvent 358, one or more solvent tanks, one or more solvent pressure regulators, one or more solvent flow meters, or any combination thereof.

FIG. 4 is a schematic of an embodiment of the combined cycle power plant 10 of FIG. 1, further illustrating details of a multi-mode configuration 450 for selectively operating in the power production mode and the power consumption mode. The illustrated multi-mode configuration 450 has a power production fluid circuit 452 and a power consumption fluid circuit 454. The power production fluid circuit 452 includes an air circuit 456, a fuel circuit 458, an exhaust gas circuit 460, and a plurality of steam circuits 462. The power consumption fluid circuit 454 includes a plurality of air circuits 464. As discussed in further detail below, the control system 144 is configured to selectively use the power production fluid circuit 452 and the power consumption fluid circuit 454 of the multi-mode configuration 450 to change between the power production mode (e.g., firing mode or combustion mode to generate electricity) and the power consumption mode (e.g., non-firing mode or non-combustion mode consuming electricity) of the combined cycle power plant 10.

The combined cycle power plant 10 has substantially the same configuration of the combined cycle power plant 10 of FIG. 1. However, the gas turbine system 12 is mechanically coupled to the steam turbine system 16 via a common shaft 466, such that the gas turbine system 12 and the steam turbine system 16 are both mechanically coupled to the motor-generator 28. However, in certain embodiments, the combined cycle power plant 10 of FIG. 4 may have the gas turbine system 12 and the steam turbine system 16 separately coupled to the motor-generator 28 and the load 116 (e.g., electrical generator) without the common shaft 466 as illustrated in FIG. 1. In either configuration, the combined cycle power plant 10 has various components and functions as already described in detail above with reference to FIG. 1. Accordingly, unless stated otherwise, the components and functions of the combined cycle power plant 10 of FIG. 4 are the same as described in detail above with reference to FIGS. 1-3. In the illustrated embodiment, the gas turbine system 12 includes the air intake section 20, the compressor section 22, the combustor section 24 having combustors 40, the turbine section 26, and the motor-generator 28. Additionally, the combined cycle power plant 10 includes the HRSG 14, the gas treatment system 18, and the exhaust stack 214. As illustrated, the gas treatment system 18 includes the gas capture systems 164 and 166. In some embodiments, the gas treatment system 18 also includes the gas capture system 162 upstream of the air intake section 20 as illustrated in FIG. 1. The illustrated steam turbine system 16 includes a plurality of steam turbines 104, such as steam turbines 468 and 470. Although the illustrated steam turbine system 16 includes only two steam turbines 104, the steam turbine system 16 may include the same steam turbine sections 106, 108, and 110 as discussed above with reference to FIG. 1.

In certain embodiments, the control system 144 may be configured to switch between the power production mode (e.g., firing mode) and the power consumption mode (e.g., non-firing mode) of the combined cycle power plant 10 using the power production fluid circuit 542 and the power consumption fluid circuit 454. In the power production mode, the gas turbine system 12 is configured to receive the air intake flow 60 from the air intake section 20 into the compressor section 22 via the air circuit 456. The air intake section 20 may include a plurality of air filters 472, which may be part of an air filter enclosure or filter housing. Thus, the air filters 472 are configured to filter the air intake flow 60 upstream of the compressor section 22. The air intake flow 60 passes through the compressor section 22, and a compressed airflow then flows to the combustors 40. The fuel circuit 458 is configured to route fuel from the fuel supply 46 into the combustors 40, such as into one or more fuel nozzles 44 as discussed above with reference to FIG. 1. The fuel mixes with the air from the compressor section 22 and combusts to generate hot combustion gases, which then flow through the turbine section 26 to drive rotation of the turbine section 26. The rotation of the turbine section 26 also drives rotation of the compressor section 22, the common shaft 466, and the motor-generator 28 (e.g., operating in a generator mode to generate electricity). The turbine section 26 then discharges an exhaust gas flow 68, which flows through the HRSG 14 before entering the gas capture systems 164 and 166 of the gas treatment system 18.

As illustrated, the HRSG 14 generates steam, which is distributed through the steam circuits 462. In the illustrated embodiment, the steam circuits 462 include steam circuits 474, 476, and 478. The steam circuit 474 extends from the HRSG 14 to the steam turbine 468, the steam circuit 476 extends from the HRSG 14 to the steam turbine 470, and the steam circuit 478 extends from the HRSG 14 to the gas capture systems 164 and 166 of the gas treatment system 18. As illustrated, the steam distributed along the steam circuit 478 serves as a heat source 480 for enabling operation of the gas capture systems 164 and 166. In some embodiments, the heat source 480 may include steam, heated water, or a combination thereof. Additionally, in some embodiments, the heat source 480 may include one or more electric heaters to add heat to generate steam and/or heated water, such as when the combined cycle power plant 10 is operating in the power consumption mode. When available, the steam may be used as the heat source 480 for desorbing the undesirable gases from a sorbent material of a sorbent-based gas capture system, stripping undesirable gases from a solvent in a solvent-based gas captured system, or any other suitable use of heat to facilitate operation of the gas capture systems 164 and 166. The stream supplied through the steam circuits 474 and 476 to the steam turbines 468 and 470 are used to drive rotation of the steam turbines 468 and 470, thereby helping to drive rotation of the motor-generator 28 (e.g., operating in the generator mode to generate electricity). Thus, in response to the rotation applied by the gas turbine system 12 and the steam turbine system 16, the motor-generator 28 operates as an electrical generator to produce electricity for a power grid.

As further illustrated, the exhaust gas flow 68 flows through the exhaust gas circuit 460 from the turbine section 26 to the exhaust stack 214, passing through a duct 482, the HRSG 14, a duct 484, the gas capture system 164, a duct 486, the gas capture system 166, a duct 488, and the exhaust stack 214. The ducts 482, 484, 486, and 488 may be duct portions of a common duct, or separate duct sections between the illustrated components. Downstream of the gas capture systems 164 and 166, the exhaust gas flow 68 is discharged as treated gas 490 (e.g., reduced content of the undesirable gases). The gas capture systems 164 and 166 operate as discussed in detail above with reference to FIG. 1. As illustrated, in the power production mode, the exhaust gas flow 68 is treated by both of the gas capture systems 164 and 166, thereby increasing the amount of gas capture performed on the exhaust gas flow 68 before discharge through the exhaust stack 214. The gas capture systems 164 and 166 are configured to produce or output the captured gas 194 (e.g., captured CO₂), which is then routed to the compression system 188 for gas compression prior to distribution through the storage/pipeline 228. In the power production mode, the air circuits 464 may or may not be used to route an airflow into the gas capture systems 164 and/or 166 to facilitate air treatment of the environmental air. Additionally, in certain embodiments, one or more additional combustion systems may route an exhaust gas into one or both of the gas capture systems 164 and 166 for gas treatment as discussed in further detail below.

In the power consumption mode of the combined cycle power plant 10, the control system 144 is configured to use the power consumption fluid circuit 454 to route one or more airflows through the air circuits 464 to one or both of the gas capture systems 164 and 166 for air treatment. For example, the power consumption fluid circuit 454 may include a plurality of air movers 492, such as an air mover 494, an air mover 496, and an air mover 498. The air movers 492 also may include the compressor section 22 of the gas turbine system 12, wherein the compressor section 22 is configured to route an airflow internally through the gas turbine system 12 without combustion of fuel with the air.

In the illustrated embodiment, the air mover 494 is mechanically coupled to and driven by the motor-generator 28 (e.g., operating in a motor mode). For example, the motor-generator 28 may be coupled to the air mover 494 via a clutch 500, while the motor-generator 28 is coupled to the steam turbine system 16 and gas turbine system 12 via a clutch 502. Each of the clutches 500 and 502 may include clutch portions 504 and 506, such as clutch plates or other engageable clutch members, configured to selectively engage and disengage rotation between the motor-generator 28 and the respective components, e.g., the air mover 494 and the steam turbine system 16 and the gas turbine system 12. In some embodiments, one or more additional clutches may be used to independently engage and disengage the steam turbine system 16 and the gas turbine system 12. For example, the steam turbine system 16 may be repositioned to another location to enable placement of an additional clutch. The clutch 500 is disposed between a shaft 508 of the motor-generator a shaft of the air mover 494. The clutch 502 is disposed between a shaft 512 of the motor-generator 28 and a shaft 514 of the steam turbine system 16.

In the power consumption mode, the motor-generator 28 may be operated as an electric motor to drive rotation of the air mover 494, the steam turbine system 16, and the gas turbine system 12 (e.g., driving the compressor section 22), only to drive the air mover 494, or only to drive the steam turbine system 16 and the gas turbine system 12 (e.g., driving the compressor section 22). For example, the control system 144 may selectively operate the clutch 502 to separate the motor-generator 28 from the steam turbine system 16 and the gas turbine system 12 while operating the clutch 500 to connect the motor-generator 28 to the air mover 494, thereby enabling the motor-generator 28 (e.g., operating in the motor mode) to drive the air mover 494 to provide an airflow through the air circuits 464. Additionally, the control system 144 may be configured to operate the clutch 500 to disconnect the motor-generator 28 from the air mover 494 and to operate the clutch 502 to connect the motor-generator 28 to the steam turbine system 16 and the gas turbine system 12, thereby enabling the motor-generator 28 (e.g., operating in the motor mode) to drive rotation of the steam turbine system 16 and the gas turbine system 12 (e.g., driving the compressor section 22).

As appreciated, when the motor-generator 28 (e.g., operating in the motor mode) drives rotation of the steam turbine system 16 and the gas turbine system 12, the compressor section 22 is enabled to compress the air intake flow 60 in one or more compressor stages to provide airflow to the gas capture systems 164 and/or 166 downstream from the gas turbine system 12. For example, the airflow may pass internally through the compressor section 22, the combustor section 24, and the turbine section 26, and then flow to the gas capture systems 164 and/or 166. However, in some embodiments, a portion or all of the airflow may be bled or otherwise extracted from the compressor section 22, the combustor section 24, the turbine section 26, and/or downstream from the turbine section 26, and then routed to the gas capture systems 164 and/or 166.

Although the compressor section 24 may be used alone as an air mover 492 to induce an airflow to the gas capture systems 164 and/or 166, any one or more of the air movers 494, 496, and 498 also may be used to induce the airflow to the gas capture systems 164 and/or 166. For example, the air movers 492 may include the air movers 496 and 498 driven by respective electric motors 516 and 518. Accordingly, the electric motors 516 and 518 may be controlled by the control system 144 to rotate the air movers 496 and 498 to provide an airflow through the air circuits 464 to the gas capture systems 164 and/or 166 alone or in combination with the airflow provided by the compressor section 22. In some embodiments, any one or more of the air movers 492 (e.g., compressor section 22 and air movers 494, 496, and 498) may be used to provide the airflow to the gas capture systems 164 and/or 166, and also the gas capture system 162 as discussed above with reference to FIG. 1.

In the illustrated embodiment, the air mover 496 driven by the electric motor 516 may be disposed in or coupled to the air intake section 20, such that the air mover 496 pushes or pulls an airflow through the air filter 472 before distributing the airflow to the gas capture systems 164 and/or 166. The air mover 498 driven by the electric motor 518 may be independent from other components of the combined cycle power plant 10, such as a standalone air mover 498. The air movers 494, 496, and 498 may include one or more of an air compressor, a fan, a blower, or any combination thereof. In certain embodiments, the power consumption fluid circuits 454 also may include one or more air filters 520 separate from the air intake section 20, such as a standalone air filter unit for the power consumption mode.

The plurality of air circuits 464 may include an air circuit 522, an air circuit 524, an air circuit 526, and an air circuit 528. The air circuit 522 may extend internally through the gas turbine system 12 from the air intake section 20 to the duct 482. For example, the air circuit 522 may include the air intake circuit 456 from the air intake section 20 into the compressor section 22, an airflow path through the compressor section 22, an airflow path through the combustors 40, and an airflow path through the turbine section 26 to the duct 482. Thus, the air circuit 522 may be described as an internal airflow circuit through the gas turbine system 12.

The air circuits 524, 526, and 528 may be described as external air circuits, independent air circuits, or secondary air circuits outside of the gas turbine system 12. In the illustrated embodiment, the air circuit 524 extends from a first position (e.g., air extraction connection) to a second position (e.g., air injection position), wherein the first position is fluidly coupled to the duct 482 between the turbine section 26 and the HRSG 14, and the second position is fluidly coupled to the duct 486 between the gas capture system 164 and the gas capture system 166. Accordingly, the air circuit 524 may be described as a bypass circuit, which bypasses the HRSG 14 and the gas capture system 164. The air circuit 524 selectively provides a bypass air 530 from the air circuit 522 to the gas capture system 166 via the duct 486.

The air circuit 526 extends from a first position (e.g., air extraction connection or compressor bleed connection) to a second position (e.g., air injection position), wherein the first position is fluidly coupled to the compressor section 22 and the second position is fluidly coupled to the duct 486. The air circuit 526 is configured to provide a bleed air 532 from the airflow path in the compressor section 22 to the gas capture system 166 without passing the airflow through the combustors 40 and the turbine section 26. The air circuit 524 may be described as a bleed air circuit, which may be controlled by the control system 144 to adjust pressures or pressure ratios across the gas turbine system 12 if suitable to help operation of the gas turbine system 12 when driven by the motor-generator 28 (e.g., operating in the motor mode) in the power consumption mode. The air circuit 526 also may include one or more coolers 534 configured to cool the temperature of the bleed air 532 before routing the airflow into the gas capture system 166. The coolers may include heat exchangers, which exchange heat with a liquid coolant (e.g., water) or gas coolant (e.g., air) to reduce the temperature of the bleed air 532.

The air circuit 528 may extend from one or more of the air movers 494, 496, and 498 to the duct 486 upstream of the gas capture system 166. Accordingly, the air circuit 528 provides an added air 536, which is generally separate from the airflow provided through the air circuit 522 inside of the gas turbine system 12. The added air 532 may be filtered by one or more of the air filters 520 along the air circuit 528. The added air 536 may selectively receive an airflow from one or more of the air movers 494, 496, and 498. For example, the air mover 494 driven by the motor-generator 28 (e.g., operating in a motor mode) may be configured to provide an airflow to the air filter 520 via an air circuit 538 and/or the air mover 494 may be configured to provide an airflow through an air circuit 540 coupled to the air intake section 20. If air is provided into the air intake section 20 from the air mover 494, the airflow may be distributed along either the air intake circuit 456 into the compressor section 22 (e.g., through air circuit 522) and/or along an air circuit 542 into the air filter 520. Similarly, inside the air intake section 20, the air mover 496 driven by the electric motor 516 may be configured to provide the airflow for distribution along either the air intake circuit 456 into the compressor section 22 (e.g., through air circuit 522) and/or along the air circuit 542 into the air filter 520. Additionally, the air mover 498 driven by the electric motor 518 may be configured to provide an airflow to the air filter 520 via an air circuit 544. At the air filter 520, any of the one or more airflows received from the air movers 494, 496, and/or 498 are then filtered to remove any undesirable particulate or water content prior to delivery through the air circuit 528 to the gas capture system 166.

The control system 144 is configured to control various airflows through the air circuits 464 via a plurality of valves 546, such as valves 548 and 550 along the air circuits 538 and 540, valves 552, 554, and 556 along the air circuits 524, 526, and 528, and valves 558 and 560 along the air circuits 456 and 542. Each of the illustrated valves 546 may include a valve assembly driven by an actuator, which is controlled by the control system 144. The valves 546 may include gate valves, ball valves, or other valve types. The actuators may include electric actuators and/or fluid actuators, such as pneumatic or hydraulic actuators. In operation, the control system 144 may selectively open and close each of the valves 546 alone or in combination with the other valves to selectively provide airflows through the various air circuits 464 to the gas capturing system 166 for air treatment during the power consumption mode. Additionally, in combination with control of the valves 546, the control system 144 may be configured to control the motor-generator 28 (e.g., operating in the motor mode), the clutches 500 and 502, and the electric motors 516 and 518 to operate the various air movers 492 to route an airflow through the various air circuits 464 to the gas capture system 166. In some embodiments, the air circuits 524, 526, and 528 may be selectively coupled to both of the gas capture systems 164 and 166, such that valves 546 can be selectively opened or closed to direct the airflows through both of gas capture systems 164 and 166, only the gas capture system 164, or only the gas capture system 166.

The control system 144 may control the airflows in a variety of ways for air treatment in the gas treatment system 18 during the power consumption mode. As an example, the control system 144 may selectively operate the clutch 502 to connect the motor-generator 28 (e.g., operating in a motor mode) to the compressor section 22 of the gas turbine system 12 to rotate the compressor section 22 and generate a compressed airflow internally through the gas turbine system 12 via air circuit 522, thereby directing airflow through the air circuit 456 from the air intake section 20 into the compressor section 22, through the combustor section 24, and through the turbine section 26. Additionally, the airflow may be routed through the air circuit 524 from the duct 482 to the duct 486 upstream of the gas capture system 166 and/or through the air circuit 526 from the compressor section 22 to the duct 486 upstream of the gas capture system 166. For example, while the motor-generator 28 is operating in the motor mode to drive the compressor section 22 when the clutch 502 mechanically couples the motor-generator 28 to the compressor section 22, the control system 144 may selectively open the valve 552 to enable the bypass air 530 and/or selectively open the valve 554 to enable the bleed air 534. When the valve 552 is open, the bypass air 530 flow through the air circuit 524 to the gas capture system 166, while bypassing the HRSG 14 and the gas capture system 164. When the valve 554 is open, the bleed air 532 flows through the air circuit 526 to the gas capture system 166, while bypassing the combustor section 24, the turbine section 26, the HRSG 14, and the gas capture system 164. The illustrated embodiment also may include a valve or flow regulator inside the duct 482, thereby enabling the control system 144 to open and close an airflow through the HRSG 14 to the gas capture systems 164 and 166.

In some embodiments, the control system 144 may disconnect the motor-generator 28 from the steam turbine system 16 and the gas turbine system 12, such that the motor-generator 28 (e.g., operating in the motor mode) does not drive the compressor section 22 to provide the airflow through the air circuit 522. However, whether the motor-generator 28 drives or does not drive the compressor section 22, the motor-generator 28 also may be controlled along with the clutch 500 to drive the air mover 494, which in turn provides an airflow through either the air circuit 538 or the air circuit 540 as discussed in detail above. For example, the control system 144 may selectively control the motor-generator 28 and the clutch 500 to drive the air mover 494, selectively open the valve 548 to enable an airflow through the air circuit 538 to the air filter 520 and/or selectively open the valve 550 to enable airflow through the air circuit 540 through the air intake section 20 to one or both of the air circuits 456 and 542. Inside the air intake section 20, the air mover 496 also may be driven by the respective electric motor 516 to provide an airflow along one or both of the air circuits 456 and 542. In operation, the control system 144 may selectively open the valve 558 to enable the airflow to pass through the air circuit 456 and through the air circuit 522 internally within the gas turbine system 12 as discussed above and/or to open the valve 560 to enable airflow to pass through the air circuit 542 to the air filter 520. The airflow passing through the air circuits 538 and 542 may then flow from the air filter 520 through the air circuit 528 as an added air 536 to the gas capture system 166. Additionally, the control system 144 may selectively operate the electric motor 518 to drive the air mover 498 to provide an airflow through the air circuit 544 to the air filter 520, which in turn provides a filtered air through the air circuit 528 as an added air 536 to the gas capture system 166.

The control system 144 is configured to enable any one or more of these airflows to pass through the air circuits 464 to the gas capture system 166. In the illustrated embodiment, the various airflows may bypass the gas capture system 164 and only flow to the gas capture system 166. However, in certain embodiments, the various air circuits 464 may be configured to route one or more of the airflows to the gas capture system 164 without the gas capture system 166 or through both of the gas capture systems 164 and 166. Additionally, in some embodiments, the various air circuits 464 may be configured to route one or more of the airflows to the gas capture system 162 upstream of the air intake section 20, as illustrated in FIG. 1.

In the power consumption mode, the various air movers 492 provide the airflow to the gas capture system 166 (and possibly any combination of the gas capture systems 162, 164, and 166), which use one or more heat sources 562 to support the gas capture processes (e.g., heat for desorption of undesirable gases from sorbent material and/or heat for stripping undesirable gases from solvent). For example, the power consumption fluid circuit 454 may include one or more heat sources 562, such as one or more heat exchangers 564 and one or more heaters 566. The heat exchangers 564 may be configured to exchange heat between a heated fluid and a working fluid, wherein the heated fluid may include a compressed air or fluid heated by waste heat. Although the gas turbine system 12 is not generating a combustion gas and an exhaust gas during the power consumption mode, other sources of a combustion gas and an exhaust gas may be used for heat transfer in the heat exchanger, depending on the availability during the power consumption mode. The working fluid may include water, air, or another suitable liquid or gas, which may be routed through the gas capture system 166 to facilitate the separation of gases in the gas capture system 166. The one or more heaters 566 may include electric heaters, which generally consume electricity to provide heat into the gas capture system 166. As illustrated, the heat sources 562 are configured to provide heat into the gas capture system 166 as illustrated by arrow 568. The heat 568 may be configured to facilitate desorption of undesirable gases from the airflow in sorbent material of a sorbent-based gas capture system, separation of gases from solvents in a solvent-based gas capture system, or any other suitable configuration. Accordingly, the heat sources 562 may be used as an alternative to the steam used in the steam circuit 578, wherein the steam may be generally available during the power production mode but unavailable during the power consumption mode. As a result, in the power consumption mode, the steam may be unavailable and thus the steam circuit 478 may not be used to provide heat to the gas capture systems 164 and 166. In certain embodiments, the heat sources 562 (e.g., heaters 566) may be used to generate steam for the heat 568, where the heat sources 562 may be independent or integrated with the HRSG 14 or other steam generators.

The gas capture system 166 is configured to capture one or more undesirable gases from the airflows as the captured gas 194 and output the treated gas 490 through the exhaust stack 214. The treated gas 490 may be described as a treated air (e.g., carbon reduced air), which has a lower content of the undesirable gases than a surrounding or ambient air. The captured gas 194 includes one or more of the undesirable gases captured from the airflows. The captured gas 194 may include carbon dioxide (CO₂) or other undesirable gases as discussed above. The captured gas 194 then passes to the compression system 188 and the storage pipeline 228.

In operation, the combined cycle power plant 10 may be selectively controlled by the control system 144 to operate in either the power production mode (e.g., firing mode) of the gas turbine system 12 or the power consumption mode (e.g., non-firing mode) of the gas turbine system 12 depending on various operating parameters and external factors. As discussed above, the external factors may include the energy pricing for electricity on the power grid, the energy demand for electricity on the power grid, various energy credits (e.g., monetary credits due to negative energy pricing), various gas capture credits (e.g., tax credits for carbon capture), or any combination thereof. For example, the control system 144 may switch between the power production mode and the power consumption mode depending on whether the energy demand and/or energy pricing is above or below one or more thresholds. For example, if the energy pricing falls to a low, zero, or negative energy pricing, then the control system 144 may transition from the power production mode to the power consumption mode. If the energy pricing rises above a threshold or positive energy pricing, then the control system 144 may transition from the power consumption mode to the power production mode. Additionally, if credits are available for reducing undesirable gases from the air, such as reducing carbon dioxide in the air, then the control system 144 may be configured to transition from the power production mode to the power consumption mode if the energy demand and/or energy pricing is also sufficiently low. Regardless of the reasons, the control system 144 is configured to enable operation in either one of the operating modes.

The power production mode, as discussed above, generally involves combusting fuel from the fuel supply 46 with air from the air intake section 20 to produce hot combustion gases, which drive the turbine section 26 and provide heat for steam generation in the HRSG 14. The steam is then used for driving the steam turbines 104 in the steam turbine system 16. Thus, the gas turbine system 12 and the steam turbine system 16 may be used to drive the same or different electrical generators (e.g., motor-generator 28 in generator mode and load 116 as electrical generator). For example, the combined cycle power plant 10 may include the configuration of the gas turbine system 12 and the steam turbine system 16 as illustrated in FIG. 1 or the series configuration of the gas turbine system 12 and the steam turbine system 16 as illustrated in FIG. 4. In the power production mode, the control system 114 may not operate the various air movers 492 that circulate or provide airflow through the air circuits 464 to the gas capture system 166.

However, when operating in the power consumption mode, the control system 144 may enable airflow through one or more of the air circuits 464 from the air movers 492 to the gas capture system 166 for air treatment to produce the treated gas 490 and the capture gas 194. In the power consumption mode, the gas turbine system 12 does not fire or combust fuel from the fuel supply 46 to generate hot combustions gases to drive the turbine section 26 and generates steam via the HRSG 14. Accordingly, the motor-generator 28 is operated in a motor mode to drive the compressor section 22 of the gas turbine system 12 and/or the air mover 494. Additionally, the air movers 496 and 498 may be driven by respective electric motors 516 and 518 to provide airflows through the air circuits 464 to the gas capture system 166. Any one or more of the air circuits 464 may be used by the power consumption fluid circuit 454 during the power consumption mode. In certain embodiments, the combined cycle power plant 10 may have a different configuration, a different combustion system than the gas turbine system 12, and/or additional combustion systems (e.g., additional gas turbine systems 12, reciprocating piston-cylinder engines, furnaces, boilers, etc.). Various configurations are discussed in further detail below.

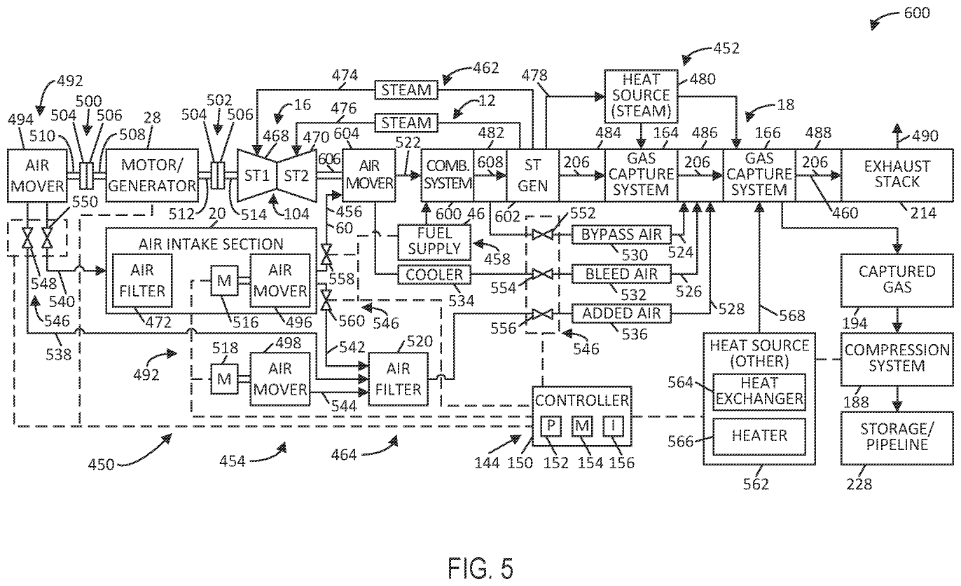

FIG. 5 is a schematic of an embodiment of a power plant 600, wherein the power plant 600 has the multi-mode configuration 450 for selectively operating in the power production mode and the power consumption mode as discussed above. In contrast to the combined cycle power plant 10 of FIG. 4, the power plant 600 has a combustion system 600 and a steam generator 602, rather than the gas turbine system 12 and the HRSG 14 of FIG. 4. Otherwise, the power plant 600 is substantially the same as the combined cycle power plant 10 described in detail above with reference to FIGS. 1-4. Accordingly, unless stated otherwise, each of the components and functions of the power plant 600 are the same as discussed in detail above with reference to FIGS. 1-4.

The combustion system 600 may include the gas turbine system 12 or a non-gas turbine system configuration. In certain embodiments, the combustion system 600 may include a furnace, a reciprocating piston-cylinder engine, or another fuel driven combustion system. For example, the combustion system 600 may include a coal-fired furnace, or a fuel-fired furnace operating with a variety of liquid fuels, gaseous fuels, or solid fuels. The fuels may include coal, petroleum products, natural gas, synthesis gas, gasoline, biofuels, or other suitable fuels. The combustion system 600 may receive an airflow from the air intake section 20 as discussed in detail above. However, the compressor section 22 of the gas turbine system 12 may be replaced with an air mover 604, which may be driven by the steam turbine system 16 or a separate electric motor. As illustrated, the air mover 604 is driven by the steam turbine system 16 via a shaft 606. The air mover 604 may include an air compressor, a fan, a blower, or another suitable air moving system. The air mover 604 provides an airflow into the combustion system 600, which also receives one or more fuels from the fuel supply 46. The combustion system 600 is configured to combust the one or fuels with the airflow from the air mover 604, thereby generating hot combustion gases as indicated by arrow 608. The hot combustion gases 608 then flow through the steam generator 602, which heats water to generate the steam for supply through the steam circuits 462 as discussed in detail above. Otherwise, the power plant 600 operates substantially the same as discussed in detail above with reference to FIG. 4.

The combustion system 600 may include a reciprocating piston-cylinder engine, and thus, the power plant 600 may be a combined cycle power plant using work extracted from the reciprocating piston-cylinder engine to drive the motor-generator 28 as an electric generator in the same configuration as discussed above with reference to FIG. 4. Alternatively, the combustion system 600 may include a fuel-fired furnace, which provides the hot combustion gases 608 to the steam generator 602 to produce the steam for operating the steam turbine system 16. However, the combustion system 600, when configured as a furnace, may not produce mechanical work to drive the motor-generator 28 as the electric generator. Accordingly, the combustion system 600, when configured as a furnace, may only be used to provide heat to generate the steam in the steam generator 602 for the steam turbine system 16. Nevertheless, the power plant 600 is configured to operate in the power production mode and the power consumption mode in the same manner as discussed in detail above with reference to FIGS. 1 and 4. Accordingly, in the power consumption mode, the control system 144 is configured to route one or more airflows through the air circuits 464 to the gas capture system 166 for treatment of the air and capture of the undesirable gases as the captured gas 194. In contrast, in the power production mode, the control system 144 is configured to operate the combustions system 600 to provide the hot combustion gases 608 for steam generation via the steam generator 602, wherein the steam is in turn used by the steam turbine system 16 to generate electricity.

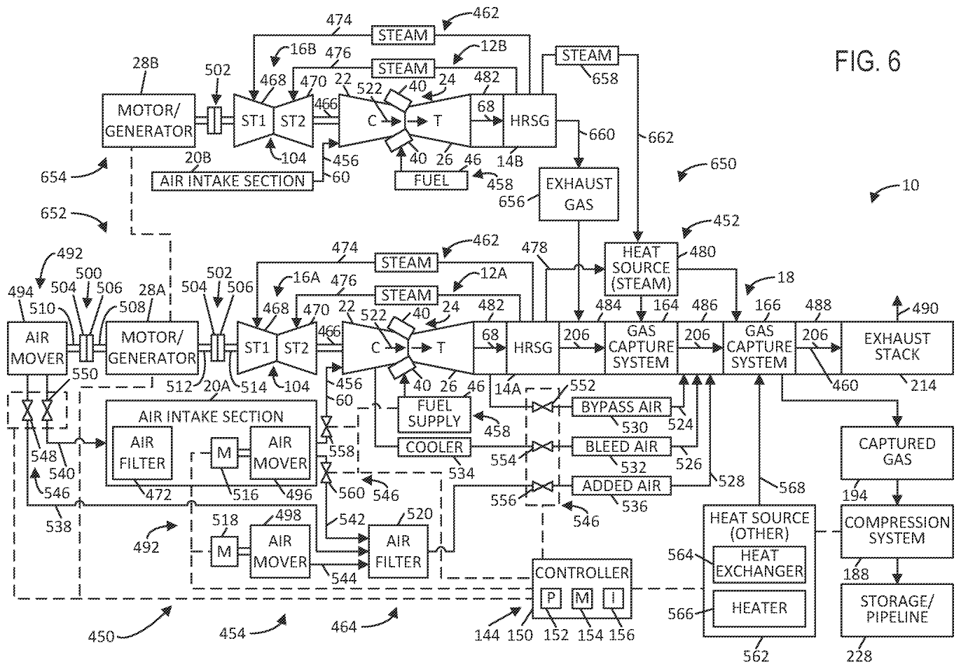

FIG. 6 is a schematic of an embodiment of the combined cycle power plant 10 of FIGS. 1 and 4, further illustrating a plurality of power trains 650 having gas turbine systems 12, steam turbine systems 16, HRSG's 14, and motor-generators 28. In the illustrated embodiment, the power trains 650 include first and second power trains 652 and 654. However, any number of additional power trains 650 may be included in the combined cycle power plant 10. The first power train 652 includes a gas turbine system 12A, an HRSG 14A, a steam turbine system 16A, and a motor-generator 28A. Similarly, the second power train 654 includes a gas turbine system 12B, an HRSG 14B, a steam turbine system 16B, and a motor-generator 28B. In general, the components of the first and second power train 652 and 654 are substantially the same as one another and are as described in detail above with reference to FIGS. 1 and 4. Additionally, each of the components and functionalities of the combined cycle power plant 10 are the same as described above with reference to FIGS. 1-4.

The combined cycle power plant 10 may include the various control modes, such as power production mode and the power consumption mode, operated by the control system 144 as discussed above. Additionally, the control system 144 is configured to control operation of the plurality of power trains 650 to operate all of the power trains 650 in a same operational mode, different operational modes, or any other suitable arrangement. For example, the control system 144 may be configured to operate all of the power trains 650 in a power production mode, all of the power train 650 in a power consumption mode, or a combination of the power production and power consumption modes.

For example, in certain embodiments, the control system 144 may be configured to operate the first power train 652 in the power consumption mode as discussed in detail above with reference to FIG. 4, while operating the second power train 654 in the power production mode. In such a configuration, the second power train 654 operating in the power production mode, may be configured to provide exhaust gas 656 and steam 658 to the gas treatment system 18 having the gas capture systems 164 and 166. For example, the second power train 654 may output the exhaust gas 656 along a circuit 660 coupled to the duct 484 upstream of the gas capture system 164 and may supply the steam 658 through a circuit 662 to the gas capture systems 164 and 166. Thus, in the illustrated embodiment, while the first power train 652 operates in a power consumption mode as discussed above, the second power train 654 operates in the power production mode to supply the steam 658 as the heat source 480 to facilitate operation of the gas capture systems 164 and 166, while also passing the exhaust gas 656 through both of the gas capture systems 164 and 166 for treatment of the exhaust gas. The illustrated embodiment can simultaneously treat the exhaust gas 656 from the second power train 654 using both of the gas capture systems 164 and 166 while also treating one or more airflows provided through the air circuits 464 to the gas capture system 166. In certain embodiments, the control system 144 may control a proportion of the exhaust gas mixed with the airflows prior to treatment in the gas capture system 166, thereby helping to control a temperature, humidity, or other parameters of the gas mixture (e.g., exhaust gas and air) being treated by the gas capture system 166. For example, the exhaust gas may be used to increase an inlet temperature and a humidity of the gas mixture (e.g., exhaust gas and air) being routed into the gas capture system 166 for treatment. In other words, ambient air can be mixed with the exhaust gas being supplied to the gas capture system 166, thereby helping with control of the gas capture process. The control system 144 may be configured to control the amounts of airflow provided to the gas capture system 166 to use available capacity of the gas capture system 166. In some embodiments, the airflows provided by the air circuits 464 may be routed to the duct 484 along with the exhaust gas 656, such that both the exhaust gas 656 and the airflows are treated by both the gas capture systems 164 and 166.

In some embodiments, the first and second power trains 652 and 654 may be simultaneously operated in the power consumption mode, thereby providing airflows to the gas treatment system 18 for increased airflows for air treatment and capture of undesirable gases as the captured gas 194. In these embodiments, the airflows may be provided to the gas treatment system 18 for gas treatment in one or both of the gas capture systems 164 and 166. For example, if the gas capture system 166 has sufficient capacity to handle the airflows for both of the power trains 652 and 654, then the airflows may be directed to only the gas capture system 166 for air purification. However, if the gas capture system 166 alone is insufficient to handle the airflows from both of the power trains 652 and 654, then the airflows may be directed through both of the gas capture systems 164 and 166.

Again, as discussed in detail above, when the control system 144 operates each power train 650 in the power consumption mode, the motor-generators 28A and 28B may be operated as a motor to drive rotation of at least the compressor sections 22 of the gas turbine systems 12A and 12B and optionally also the steam turbine systems 16A and 16B, such that the compressor sections 22 provide airflows through the respective gas turbine systems 12A and 12B for supply to the gas treatment system 18. Additionally, one or more of the air movers 492 may be used to provide airflows to the gas treatment system 18, such as the gas capture system 164 and/or the gas capture system 166. In the illustrated embodiment, if both of the first and second power train 652 and 654 are operating in the power consumption mode, then the heat sources 562 may be used to provide heat to support operation of the gas capture systems 164 and/or 166. However, if the power train 652 operates in the power consumption mode while the power train 654 operates in the power production mode, then the steam 658 may be used as the heat source 580 with or without the one or more heat sources 562. All other aspects of the combined cycle power plant 10 are the same as described in detail above.

FIG. 7 is a schematic of an embodiment of the power plant 600 of FIG. 5, further illustrating a plurality of power trains 700 having the combustion systems 600, the steam generators 602, the air movers 604, the steam turbines 16, and the motor-generators 28. For example, the power trains 700 may include any number of power trains having similar components and functionalities as discussed in detail above. For example, the power train 700 may include a first power train 702 including an air mover 604A, a combustion system 600A, a steam generator 602A, a steam turbine system 16A, and a motor-generator 28A. Similarly, the second power train 704 may include an air mover 604B, a combustion system 600B, a steam generator 602B, a steam turbine system 16B, and a motor-generator 28B. The power trains 700, including the first and second power trains 702 and 704, are arranged in a substantially similar manner as the plurality of power trains 650 of FIG. 6. Accordingly, the operation, functionality, and control is substantially the same as discussed in detail above, with the difference being the gas turbine systems 12 and the HRSG 14 are replaced with the combustion system 600 and the steam generators 602.

In the illustrated embodiment, the power trains 700 may operate in the same or different operational modes, such as the power production mode, the power consumption mode, or a combination thereof. For example, the control system 144 may be configured to operate all of the power trains 700 in the power production mode, all of the power train 700 in the power consumption mode, or a combination of one or more of the power trains 700 operating in the power production mode and the power consumption mode. In a control configuration with all of the power trains 700 operating in the power production mode, the gas treatment system 18 is configured to treat exhaust gas from each of the power trains using the gas capture systems 164 and 166. Accordingly, the first power train 702 may combust fuel from the fuel supply and generate hot combustion gases to generate steam.

In a control configuration with the first and second power trains 702 and 704 operating in the power production mode, each of the combustion systems 600A and 600B receives fuel from the respective fuel supplies 46 and receives air from the respective air movers 604A and 604B to generate the hot combustion gas 608. The combustion gas 608 then passes through the respective steam generators 602A and 602B to generate steam for the respective steam turbine systems 16A and 16B, and an exhaust gas is discharged for treatment in the gas treatment system 18. Accordingly, the gas treatment system 18 may receive exhaust gas 656 via the circuit 660 from the steam generator 602B and exhaust gas from the steam generator 602A downstream from the respective combustion systems 600, such that the gas capture system 164 treats the exhaust gas followed by treatment in the gas capture system 166. Additionally, the steam generators 602A and 602B provide steam as the heat source 480 for supporting operation of the gas treatment systems 164 and 166.

If the control system 144 operates both of the first and second power trains 702 and 704 in the power consumption mode, then the combustion system 600A and 600B do not receive and combust fuel from the respective fuel supplies 46. Instead, the control system 144 may control flows through the air intake sections 20A and 20B and the respective air movers 604A and 604B to provide airflows through the combustion systems 600A and 600B (i.e., without any fuel combustion) for subsequent air treatment in the gas treatment system 18. Accordingly, each of the combustion systems 600A and 600B may not produce any hot combustion gas 608, but rather the combustion systems 600A and 600B merely pass an airflow for downstream air treatment in the gas treatment system 18. The airflow may pass through all of the ducts 482, 484, 486, and 488 and each of the gas treatment systems 164 and 166, or one or more of the air circuits 524, 526, and 528 may be used to route airflows to the gas capture system 166 (or any combination of the gas capture systems 162, 164, and 166) as discussed in detail above.

The control system 144 also may operate the first and second power trains 702 and 704 in different operational modes. For example, the control system 144 may operate the first power train 702 in the power consumption mode as discussed above, while operating the second power train 704 in the power production mode. While the second power train 704 operates in the power production mode, the combustion system 600B combusts a fuel to generate the hot combustion gas 608, which passes through the steam generator 602B to generate steam for the steam turbine system 16B and steam 658 for the heat source 480 as discussed above. Additionally, the second power train 704 discharges the exhaust gas 656 through the circuit 660 to the duct 484 upstream of the gas capture systems 164 and 166. Accordingly, in substantially the same manner as discussed above with reference to FIG. 6, the exhaust gas 656 may be treated by the gas capture systems 164 and 166, while one or more airflows also may be provided by the air circuits 464 for treatment in one or both of the gas capture systems 164 and 166. In certain embodiments, the control system 144 may control a proportion of the exhaust gas mixed with the airflows prior to treatment in one or both of the gas capture system 164 and 166, thereby helping to control a temperature, humidity, or other parameters of the gas mixture (e.g., exhaust gas and air) being treated by the gas capture systems 164 and/or 166. For example, the exhaust gas may be used to increase an inlet temperature and a humidity of the gas mixture (e.g., exhaust gas and air) being routed into the gas capture systems 164 and/or 166 for treatment. In other words, ambient air can be mixed with the exhaust gas being supplied to the gas capture systems 164 and/or 166, thereby helping with control of the gas capture process. In the illustrated embodiment, when steam is available, the steam 658 may be used as the heat source 480 for supporting the gas capture systems 164 and 166 with or without the heat sources 562 as discussed above. All other aspects of the power plant 600 are substantially the same as discussed in detail above with reference to FIGS. 1-6.

FIG. 8 is a flow chart of an embodiment of a process 750 for controlling operation of a power plant in the power production mode and the power consumption mode as discussed in detail above with reference to FIGS. 1-7. The process 750 may be executed by one or more controllers, such as the controller 150 of the control system 144. The process 750 may be used for any combustion-driven power plant, such as the combined cycle power plant 10, of FIGS. 1, 4, and 6 and/or the power plant 600 of FIGS. 5 and 7. In the illustrated embodiment, the process 750 may include monitoring a power demand and power prices for electricity provided by a power plant on an electric grid (block 752). For example, the process 750 may monitor for an increase or decrease in the power demand and power prices (e.g., electricity prices). The process 750 also may include a query or evaluation regarding whether the power demand and/or power prices are below a threshold (block 754). For example, the threshold may include a power demand threshold and/or a power price threshold, which is a minimum level for operating the power plant in a power production mode. Accordingly, the process 750 may proceed to control the power plant depending on whether the power demand and/or power prices are below the threshold as indicated by arrow 756 or above the threshold as indicated by arrow 758.

If the power demand and/or power prices are above the threshold as indicated by arrow 758, then the process 750 may proceed to control the power plant to operate in a power production mode (e.g., firing mode or combustion mode) and an exhaust gas treatment mode of one or more gas capture systems (block 760). The process 750 may then continue to control the combustion of fuel to generate hot combustion gas in a combustion system, such as a furnace, a gas turbine system, a reciprocating piston-cylinder engine, or any combination thereof (block 762). The process 750 may then proceed to control a generation of steam by extracting heat from the hot combustion gas (block 764). For example, the extraction of heat to generate steam may be performed via one or more HRSG's 14 and/or one or more steam generators 602. The process 750 may then proceed to control a power generation by extracting work from the hot combustion gas and/or steam (block 766). For example, the hot combustion gas may be used to drive a turbine section of a gas turbine system 12, pistons of a reciprocating piston-cylinder engine, or another engine. The steam may be used to drive one or more turbines of a steam turbine system 16. The process 750 may then proceed to control a treatment of exhaust gas in a first stage of a gas capture system using steam as a source of heat (block 768). For example, the treatment may be performed with the gas capture system 164 of the gas treatment system 18 as discussed in detail above. The steam may be used as a heat source to help desorb undesirable gases from sorbent material, separate undesirable gases from a solvent, or any combination thereof. The process 750 may then proceed to control a treatment of exhaust gas in a second stage of a gas capture system using steam as a heat source (block 770). For example, the gas treatment may be performed with the gas capture system 166 as described above. Again, the steam may be used as a heat source to help with desorption of undesirable gases from sorbent material, separation of undesirable gases from a solvent, or any combination thereof. The process 750 ultimately produces the capture gas 194 and a treated gas 490 as discussed in detail above.

If the power demand and/or power prices are below the threshold (block 754) as indicated by arrow 756, then the process 750 proceeds to control the power plant in a power consumption mode (e.g., non-firing mode or non-combustion mode) and an air treatment mode of a gas capture system (block 772). The process 750 may then proceed to control one or more compressors and/or air movers to provide an airflow along one or more of the air circuits 464 as discussed in detail above (block 774). For example, the airflows may be provided via the compressor section 22 of the gas turbine system 12, the air mover 604 of the combustion system 600, or one of the air movers 494, 496, and/or 498. The process 750 may then proceed to control a generation of heat using one or more heaters and/or heat exchangers (block 776). For example, the heat sources 562, including the heat exchangers 564 and/or heaters 566, may be used to provide heat for supporting operation of the gas capture system 166 and/or 164. The process 750 may then proceed to control an airflow through existing flow paths of the combustion system and/or other flow paths (block 778). For example, the existing flow path of the combustion system may include the air circuit 522 internally through the gas turbine system 12, the air circuit internally through the combustions system 600, or a combination thereof. The other flow paths may include one or more of the air circuits 464 described in detail above. The process 750 may then proceed to control a bypass of airflow around a steam generator and/or a first stage of gas capture (block 780). For example, the steam generator may include the HRSG 14, the steam generator 602, or a combination thereof. The first stage of gas capture may include the gas capture system 164. The bypass may include the air circuit 524 enabling the bypass air 530 as described in detail above. The process 750 may then proceed to control a treatment of the airflow in a second stage of gas capture using heat (block 782). The second stage of gas capture may include the gas capture system 166 and the heat may include the heat 568 from the one or more heat sources 562 as described in detail above. Accordingly, the airflow may be treated to remove one or more undesirable gases, such as carbon dioxide, thereby treating the air for discharge as a treated gas 490 into the environment. Additionally, the process 750 obtains the captured gas 194 (e.g., carbon capture such as CO₂). The process 750 also may include combinations of the power production mode and the power consumption mode as discussed in detail above with reference to FIGS. 6 and 7. In operation, the process s750 enables various power plants 10 to operate both for power production and power consumption depending on various external factors, such as power demand, power prices, energy credits, gas capture credits (e.g., tax credits for capturing undesirable gases), or any combination thereof. Accordingly, when the power demand and/or power prices are low, such as a low, zero, or negative power pricing, the process 750 can operate the power plant in a power consumption mode to generate energy credits and/or gas capture credits while treating the air in the environment.

Technical effects of the disclosed embodiments include a multi-stage gas treatment system having a plurality of gas capture systems 160 (e.g., 162, 164, and 166), which may include sorbent-based gas capture systems (e.g., 250, FIG. 2) and/or solvent-based gas capture systems (e.g., 350, FIG. 3) with heated fluid 168 (e.g., steam and/or heated water), waste heat from a waste heat recovery system 172 (e.g., 182, 184, and 186), and/or heat sources 562 (e.g., heat exchanger 564 and/or heater 566) as a source of heat for the gas capture processes. The disclosed embodiments substantially reduce the concentration levels of undesirable gases (e.g., CO₂) to levels at or below input levels, thereby helping to achieve a desired carbon footprint (e.g., a low carbon, a net neutral, or a net negative carbon footprint) for the combined cycle power plant 10 and/or the power plant 600. The disclosed embodiments advantageously control the power plant (e.g., 10, 600) in either the power production mode or the power production mode, thereby enabling gas capture from exhaust gas while generating electricity in the power production mode, and enabling gas capture from air (e.g., environmental air) while not producing electricity in the power consumption mode. In particular, when power demand and/or power pricing is low, zero, or negative, the power consumption mode enables additional gas capture from the environmental air that would not otherwise be possible with the power plant (e.g., 10, 600).

The subject matter described in detail above may be defined by one or more clauses, as set forth below.

A system includes a gas treatment system having a first gas capture system configured to at least partially capture an undesirable gas, and at least one gas capture system configured to at least partially capture the undesirable gas. The gas treatment system also includes an exhaust flow path through the at least one gas capture system, an airflow path through the at least one gas capture system, and at least one flow control. The at least one flow control is configured to direct an exhaust gas from a combustion system through the exhaust flow path in a first control mode to enable gas capture from the exhaust gas by the at least one gas capture system, wherein the at least one flow control is configured to direct an airflow through the airflow path in a second control mode to enable gas capture from the airflow by the at least one gas capture system.

The system of the preceding claim, including a controller having a memory, a processor, and instructions stored on the memory and executable by the processor to change operating modes between the first control mode and the second control mode.

The system of any preceding claim, wherein the first control mode includes a firing mode of the combustion system generating the exhaust gas, and the second control mode includes a non-firing mode of the combustion system not generating the exhaust gas.

The system of any preceding claim, wherein the first control mode includes a power production mode using the combustion system to generate a combustion gas as a source of energy to drive an electric generator, wherein the second control mode includes a power consumption mode using electricity to drive one or more air movers to provide the airflow through the airflow path to enable the gas capture from the airflow by the at least one gas capture system.

The system of any preceding claim, wherein the controller is configured to control a steam generator to supply steam to the at least one gas capture system in the first control mode, wherein the controller is configured to control a heater to supply heat to the at least one gas capture system in the second control mode.

The system of any preceding claim, including the combustion system and an electric generator, wherein the combustion system is configured to combust a fuel to generate a combustion gas, and the electric generator is driven using the combustion gas as a source of energy.

The system of any preceding claim, wherein the combustion system includes a gas turbine system having an air compressor, a combustor, and a turbine driven by the combustion gas and outputting the exhaust gas.

The system of any preceding claim, including a heat recovery steam generator (HRSG) and a steam turbine, wherein the HRSG is configured to generate a steam using heat from the exhaust gas, and the steam turbine is driven by the steam.

The system of any preceding claim, including a steam supply circuit configured to supply a portion of the steam to the at least one gas capture system in the first control mode, and a heater configured to supply heat to the at least one gas capture system in the second control mode.

The system of any preceding claim, wherein the combustion system includes a furnace.

The system of any preceding claim, including a steam generator and a steam turbine, wherein the steam generator is configured to generate a steam using heat from the combustion gas, and the steam turbine is driven by the steam.

The system of any preceding claim, including a steam supply circuit configured to supply a portion of the steam to the at least one gas capture system in the first control mode, and a heater configured to supply heat to the at least one gas capture system in the second control mode.

The system of any preceding claim, including one or more air movers configured to supply the airflow through the airflow path to enable the gas capture from the airflow by the at least one gas capture system.

The system of any preceding claim, wherein the one or more air movers include an air mover of the combustion system, the air mover is configured to supply the airflow through the combustion system to combust a fuel in the first control mode, and the air mover is configured to supply the airflow through the combustion system without combustion in the second mode.

The system of any preceding claim, wherein the one or more air movers include an air mover coupled to an electric motor-generator via a clutch, the electric motor-generator is coupled to a turbine, the electric motor-generator is configured to operate as an electric generator driven by the turbine in the first control mode, and the electric motor-generator is configured to operate as an electric motor to drive the air mover in the second control mode.

The system of any preceding claim, wherein the one or more air movers include an air mover driven by an electric motor.

The system of any preceding claim, wherein the undesirable gas includes carbon dioxide (CO₂).

The system of any preceding claim, wherein the at least one gas capture system includes a first gas capture system and a second gas capture system, wherein the exhaust flow path extends through a series arrangement of the first and second gas capture systems, wherein the airflow path extends through the second gas capture system.

A system includes a controller having a memory, a processor, and instructions stored on the memory and executable by the processor to change operating modes between a first control mode and a second control mode of a gas treatment system, wherein the gas treatment system includes at least one gas capture system configured to at least partially capture an undesirable gas. The controller is configured to control at least one flow control to direct an exhaust gas from a combustion system through the at least one gas capture system along an exhaust flow path in the first control mode, wherein the first control mode enables gas capture from the exhaust gas by the at least one gas capture system. The controller is configured to control the at least one flow control to direct an airflow through the at least one gas capture system along an airflow path in the second control mode, wherein the second control mode enables gas capture from the airflow by the at least one gas capture system.

A method includes changing operating modes between a first control mode and a second control mode of a gas treatment system, wherein the gas treatment system includes at least one gas capture system configured to at least partially capture an undesirable gas. The method includes controlling at least one flow control to direct an exhaust gas from a combustion system through the at least one gas capture system along an exhaust flow path in the first control mode, wherein the first control mode enables gas capture from the exhaust gas by the at least one gas capture system. The method includes controlling the at least one flow control to direct an airflow through the at least one gas capture system along an airflow path in the second control mode, wherein the second control mode enables gas capture from the airflow by the at least one gas capture system.

This written description uses examples to describe the present embodiments, including the best mode, and also to enable any person skilled in the art to practice the presently disclosed embodiments, including making and using any devices or systems and performing any incorporated methods. The patentable scope of the presently disclosed embodiments is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a gas treatment system, comprising:
at least one gas capture system configured to at least partially capture the undesirable gas;
an exhaust flow path through the at least one gas capture system;
an airflow path through the at least one gas capture system; and
at least one flow control, wherein the at least one flow control is configured to direct an exhaust gas from a combustion system through the exhaust flow path in a first control mode to enable gas capture from the exhaust gas by the at least one gas capture system, wherein the at least one flow control is configured to direct an airflow through the airflow path in a second control mode to enable gas capture from the airflow by the at least one gas capture system.

2. The system of claim 1, comprising a controller having a memory, a processor, and instructions stored on the memory and executable by the processor to change operating modes between the first control mode and the second control mode.

3. The system of claim 2, wherein the first control mode comprises a firing mode of the combustion system generating the exhaust gas, and the second control mode comprises a non-firing mode of the combustion system not generating the exhaust gas.

4. The system of claim 3, wherein the first control mode comprises a power production mode using the combustion system to generate a combustion gas as a source of energy to drive an electric generator, wherein the second control mode comprises a power consumption mode using electricity to drive one or more air movers to provide the airflow through the airflow path to enable the gas capture from the airflow by the at least one gas capture system.

5. The system of claim 4, wherein the controller is configured to control a steam generator to supply steam to the at least one gas capture system in the first control mode, wherein the controller is configured to control a heater to supply heat to the at least one gas capture system in the second control mode.

6. The system of claim 1, comprising the combustion system and an electric generator, wherein the combustion system is configured to combust a fuel to generate a combustion gas, and the electric generator is driven using the combustion gas as a source of energy.

7. The system of claim 6, wherein the combustion system comprises a gas turbine system having an air compressor, a combustor, and a turbine driven by the combustion gas and outputting the exhaust gas.

8. The system of claim 7, comprising a heat recovery steam generator (HRSG) and a steam turbine, wherein the HRSG is configured to generate a steam using heat from the exhaust gas, and the steam turbine is driven by the steam.

9. The system of claim 8, comprising a steam supply circuit configured to supply a portion of the steam to the at least one gas capture system in the first control mode, and a heater configured to supply heat to the at least one gas capture system in the second control mode.

10. The system of claim 6, wherein the combustion system comprises a furnace.

11. The system of claim 10, comprising a steam generator and a steam turbine, wherein the steam generator is configured to generate a steam using heat from the combustion gas, and the steam turbine is driven by the steam.

12. The system of claim 11, comprising a steam supply circuit configured to supply a portion of the steam to the at least one gas capture system in the first control mode, and a heater configured to supply heat to the at least one gas capture system in the second control mode.

13. The system of claim 1, comprising one or more air movers configured to supply the airflow through the airflow path to enable the gas capture from the airflow by the at least one gas capture system.

14. The system of claim 13, wherein the one or more air movers comprise an air mover of the combustion system, the air mover is configured to supply the airflow through the combustion system to combust a fuel in the first control mode, and the air mover is configured to supply the airflow through the combustion system without combustion in the second mode.

15. The system of claim 13, wherein the one or more air movers comprise an air mover coupled to an electric motor-generator via a clutch, the electric motor-generator is coupled to a turbine, the electric motor-generator is configured to operate as an electric generator driven by the turbine in the first control mode, and the electric motor-generator is configured to operate as an electric motor to drive the air mover in the second control mode.

16. The system of claim 13, wherein the one or more air movers comprise an air mover driven by an electric motor.

17. The system of claim 1, wherein the undesirable gas comprises carbon dioxide (CO₂).

18. The system of claim 1, wherein the at least one gas capture system comprises a first gas capture system and a second gas capture system, wherein the exhaust flow path extends through a series arrangement of the first and second gas capture systems, wherein the airflow path extends through the second gas capture system.

19. A system, comprising:
a controller having a memory, a processor, and instructions stored on the memory and executable by the processor to:
change operating modes between a first control mode and a second control mode of a gas treatment system, wherein the gas treatment system comprises at least one gas capture system configured to at least partially capture an undesirable gas;
control at least one flow control to direct an exhaust gas from a combustion system through the at least one gas capture system along an exhaust flow path in the first control mode, wherein the first control mode enables gas capture from the exhaust gas by the at least one gas capture system; and
control the at least one flow control to direct an airflow through the at least one gas capture system along an airflow path in the second control mode, wherein the second control mode enables gas capture from the airflow by the at least one gas capture system.

20. A method, comprising:
changing operating modes between a first control mode and a second control mode of a gas treatment system, wherein the gas treatment system comprises at least one gas capture system configured to at least partially capture an undesirable gas;
controlling at least one flow control to direct an exhaust gas from a combustion system through the at least one gas capture system along an exhaust flow path in the first control mode, wherein the first control mode enables gas capture from the exhaust gas by the at least one gas capture system; and
controlling the at least one flow control to direct an airflow through the at least one gas capture system along an airflow path in the second control mode, wherein the second control mode enables gas capture from the airflow by the at least one gas capture system.
